(19) United States
(12) Patent Application Publication
(10) Pub. No.: US 2016/0033831 A1
(43) Pub. Date: Feb. 4, 2016

(54) LIQUID CRYSTAL DISPLAY DEVICE

(71) Applicant: SHARP KABUSHIKI KAISHA, Osaka (JP)

(72) Inventors: Hiroshi TSUCHIYA, Osaka-shi (JP); Tsuyoshi OKAZAKI, Osaka-shi (JP)

(21) Appl. No.: 14/782,802

(22) PCT Filed: Mar. 4, 2014
(86) PCT No.: PCT/JP2014/055434

§ 371 Date: Oct. 7, 2015

(30) Foreign Application Priority Data
Apr. 19, 2013 (JP) 2013-088595

(51) Int. Cl. G02F 1/1343; G02F 1/1335

(52) U.S. Cl. CPC G02F 1/134363; G02F 1/13439; G02F 1/133528; G02F 2001/133531

(57) ABSTRACT

The present invention provides a liquid crystal display device capable of achieving favorable display properties even when the pixel size is small. The liquid crystal display device includes a first substrate; a second substrate; and a liquid crystal layer sandwiched between the first substrate and the second substrate, the first substrate provided with electrode pairs each including a first hook-like electrode and a second hook-like electrode that are independent of each other, the first hook-like electrodes, included in respective two adjacent electrode pairs, being connected to each other by a first connection line, the second hook-like electrodes, included in the respective two adjacent electrode pairs, being connected to each other by a second connection line, the first hook-like electrode included in one of the two adjacent electrode pairs and the first hook-like electrode included in the other of the two adjacent electrode pairs arranged symmetrically about the second connection line arranged between the electrode pairs as a reference axis, and the second hook-like electrode included in one of the two adjacent electrode pairs and the second hook-like electrode included in the other of the two adjacent electrode pairs arranged symmetrically about the second connection line, the inner periphery of the first hook-like electrode and the inner periphery of the second hook-like electrode in each pair facing each other in a plan view of the first substrate.

### TECHNICAL FIELD

The present invention relates to a liquid crystal display device. The present invention more specifically relates to a liquid crystal display device in a transverse electric field mode.

### BACKGROUND ART

Liquid crystal display devices control transmission/blocking of light (ON/OFF of display) by controlling the alignment of liquid crystal molecules having a birefringence. Liquid crystal display devices may be in a liquid crystal alignment mode such as a twisted nematic (TN) mode in which the alignment of liquid crystal molecules having positive anisotropy of dielectric constant is twisted by 90° in a view from the normal direction of the substrates; a vertical alignment (VA) mode in which liquid crystal molecules having negative anisotropy of dielectric constant are aligned perpendicularly to the substrate surfaces; and an in-plane switching (IPS) mode and a fringe field switching (FFS) mode in each of which liquid crystal molecules having positive or negative anisotropy of dielectric constant are aligned in parallel with the substrate surfaces, and a transverse electric field is applied to the liquid crystal layer.

A widely spread drive method for liquid crystal display devices is an active matrix drive method that arranges active elements such as thin film transistors (TFTs) for respective pixels, and provides high-definition images. In an array substrate provided with TFTs and pixel electrodes, scanning signal lines and data signal lines are formed to intersect each other, and a TFT is provided to each intersection. The TFTs each are connected to a pixel electrode, and have a switching function that controls supply of image signals to the pixel electrode. The array substrate or the counter substrate is further provided with common electrodes, and by the electrode pairs, voltage is applied to the liquid crystal layer.

In the IPS mode, which is one of the methods of applying a transverse electric field to control the alignment of liquid crystal molecules, the pixel electrodes and the common electrodes are formed on the same substrate, and both kinds of the electrodes are formed to have comb teeth. The comb teeth of a pixel electrode and the comb teeth of a common electrode in one pixel are parallel to each other, and the alignment of the liquid crystal molecules is controlled based on the electric potential difference between the comb teeth of the pixel electrode and the comb teeth of the common electrode. The comb teeth of each electrode may be partially bent, which enables achievement of excellent viewing angle characteristics (for example, Patent Literatures 1 to 3).

### CITATION LIST

### Patent Literature

Patent Literature 1: JP 3427611 B

Patent Literature 2: JP 3383205 B

Patent Literature 3: JP 3423909 B

### SUMMARY OF INVENTION

### Technical Problem

In view of the current increase in definition of pixels, the present inventors have made various studies on the design for smaller pixel sizes. As a result, the inventors have found that the electrode structures of the conventional transverse electric field modes (e.g., IPS mode, FFS mode) sometimes cannot achieve a sufficient transmittance. FIG. 59 is a schematic plan view illustrating one example of electrode arrangement of a conventional IPS mode liquid crystal display device. As illustrated in FIG. 59, in the conventional IPS mode liquid crystal display device, a pixel electrode 111 and a common electrode 115 are arranged in one pixel, and each of the electrodes includes V-shaped comb teeth that are partially bent. When the comb teeth of the electrodes 111 and 115 are arranged such that the longitudinal directions of the comb teeth are oblique to the conductive lines, a wide viewing angle can be achieved.

However, in the case of employing such V-shaped comb teeth, the number of formable comb teeth decreases as the pixel size decreases, and thus the transmittance per pixel decreases. This is because the liquid crystal molecules positioned far from electrodes do not easily receive a sufficient influence of the electric field strength, and thus the desired alignment cannot be achieved. Such a structure actually produces dark regions at the corners of pixels (regions surrounded by dotted lines at the right end in FIG. 59). Even when such dark regions are partially generated in a sufficiently large pixel, the insufficient display brightness as a whole can be compensated by the brightness in the other regions. However, since the area ratio of the dark regions to the entire pixel increases as the pixel size decreases, the influence of the decrease in the transmittance is more significant when high definition pixels are produced.

Here, it is also possible to provide a straight shape, not the V shape, to the comb teeth of the pixel electrode 111 and the common electrode 115, but the viewing angle characteristics, which are an advantage of the IPS mode, cannot be fully achieved in that case.

Also, it is possible to utilize a mode other than the IPS mode, but the only mode that can achieve a high transmittance with a small pixel size is the TN mode. The TN mode, however, has a problem in the viewing angle characteristics. Accordingly, a high transmittance and a wide viewing angle cannot be achieved at the same time by the conventional art.

The present invention has been made in view of the above current state of the art, and aims to provide a liquid crystal display device capable of achieving favorable display properties even when the pixel size is small.

### Solution to Problem

The present inventors have focused on the structures of the pixel electrodes and the common electrodes, and concluded that it is difficult to achieve a high transmittance and a wide viewing angle at the same time by simply changing the shapes of the comb teeth of the pixel electrodes and the common electrodes as in the conventional methods. The present inventors have then focused on the conventional structure in which a combination of a pixel electrode and a common electrode each including comb teeth form one pixel. As a result, the present inventors have adjusted the shapes of the pixel electrodes and the common electrodes to partially angular hook-like shapes, and controlled the alignment of the liquid crystal molecules using pairs of the hook-like electrodes by arranging the electrodes such that the inner peripheries of the corners face each other. The inventors have then found that such an arrangement of the electrodes enables alignment control of liquid crystal molecules with a small number of electrodes even when the pixel size is small. Furthermore, the present inventors have found that excellent viewing angle characteristics can be achieved by arranging pairs of hook-like electrodes such that the first hook-like electrode included in one of the two adjacent electrode pairs and the first hook-like electrode included in the other of the two adjacent electrode pairs arranged symmetrically about a conductive line arranged between the electrode pairs as a reference axis, and the second hook-like electrode included in one of the two adjacent electrode pairs and the second hook-like electrode included in the other of the two adjacent electrode pairs arranged symmetrically about the second connection line; and connecting the hook-like electrodes that are included in the respective two adjacent electrode pairs and are closer to the conductive line.

Thereby, the present inventors have solved the above problems, completing the present invention.

That is, one aspect of the present invention is a liquid crystal display device including: a first substrate; a second substrate; and a liquid crystal layer sandwiched between the first substrate and the second substrate, the first substrate provided with electrode pairs each including a first hook-like electrode and a second hook-like electrode that are independent of each other, the first hook-like electrodes, included in respective two adjacent electrode pairs, being connected to each other by a first connection line, the second hook-like electrodes, included in the respective two adjacent electrode pairs, being connected to each other by a second connection line, the first hook-like electrode included in one of the two adjacent electrode pairs and the first hook-like electrode included in the other of the two adjacent electrode pairs arranged symmetrically about the second connection line arranged between the electrode pairs as a reference axis, and the second hook-like electrode included in one of the two adjacent electrode pairs and the second hook-like electrode included in the other of the two adjacent electrode pairs arranged symmetrically about the second connection line, the inner periphery of the first hook-like electrode and the inner periphery of the second hook-like electrode in each pair facing each other in a plan view of the first substrate.

The liquid crystal display device includes a first substrate, a second substrate, and a liquid crystal layer sandwiched between the first substrate and the second substrate. The first substrate includes electrode pairs each including a first hook-like electrode and a second hook-like electrode that are independent of each other. Based on the electric potential difference between these first and second hook-like electrodes, an electric field is generated in the liquid crystal layer. The alignment of liquid crystal molecules changes with the strength of the electric field, and based on the alignment, the amount of light transmitted is controlled, so that the display is controlled to be turned on or off. The electric potentials supplied to the first and second hook-like electrodes are not particularly limited, and can be appropriately changed in view of the design.

The “hook-like electrode” herein refers to an electrode that has a bent portion (corner portion) and portions (end portions) at the each side of the corner portion. Also, in a plan view of the first substrate, a line constituting the outer edge of the “hook-like electrode” on the side where the electrode bends inwardly (acute angle side) is referred to as the “inner periphery”, and a line constituting the outer edge of the “hook-like electrode” on the side where the electrode bends outwardly (obtuse angle side) is referred to as the “outer periphery”.

The first hook-like electrodes, included in respective two adjacent electrode pairs, are connected to each other by a first connection line. The second hook-like electrodes, included in the respective two adjacent electrode pairs, are connected to each other by a second connection line. The first hook-like electrode included in one of the two adjacent electrode pairs and the first hook-like electrode included in the other of the two adjacent electrode pairs are arranged symmetrically about the second connection line arranged between the electrode pairs as a reference axis, and the second hook-like electrode included in one of the two adjacent electrode pairs and the second hook-like electrode included in the other of the two adjacent electrode pairs are arranged symmetrically about the second connection line. Herein, the hook-like electrode that is farther from the second connection line is referred to as the “first hook-like electrode”, and the hook-like electrode that is closer to the second connection line is referred to as the “second hook-like electrode”. Hence, signals with the same electric potential are supplied to the first hook-like electrodes included in the respective two adjacent electrode pairs, and signals with the same electric potential are supplied to the second hook-like electrodes included in the respective two adjacent electrode pairs. With such arrangement of the electrodes and conductive lines, the electric fields generated by the electrode pairs can be symmetric, and a wide viewing angle can be achieved without a decrease in the transmittance, even when the pixel size is small.

The structure of the liquid crystal display device is not especially limited by other components as long as it essentially includes such components. For example, different electrode(s) other than the first and second hook-like electrodes (e.g. the third, fourth, and/or so forth electrode(s)) may be provided. Here, the different electrode(s) may or may not be hook-like electrode(s).

Hereinafter, preferred structures of the liquid crystal display device are described in detail. Here, a combination of two or more of the following preferred structures of the liquid crystal display device is also one preferred structure of the liquid crystal display device.

Preferably, the second hook-like electrodes included in the respective two adjacent electrode pairs and the second connection line are arranged on the same layer, the second connection line is arranged to fill a space between the second hook-like electrodes included in the respective two adjacent electrode pairs in a plan view of the first substrate, and the second hook-like electrodes included in the respective two adjacent electrode pairs and the second connection line are integrally formed. Thereby, an arrangement structure without extra spaces can be efficiently formed, which contributes to improvement in the aperture ratio.

In terms of further improvement in the alignment controllability of the liquid crystal molecules, in a plan view of the first substrate, at least one end portion of at least one of the first hook-like electrodes preferably has a sharp tip, and both end portions more preferably have sharp tips. Also, in a plan view of the first substrate, at least one end portion of at least one of the second hook-like electrodes preferably has a sharp tip, and both end portions more preferably have sharp tips. Thereby, the liquid crystal is less likely to cause alignment disorder around the end portions of the hook-like electrodes, and thus a highly uniform liquid crystal alignment can be achieved in the entire region surrounded by at least one pair of hook-like electrodes.

In terms of further improvement in the alignment controllability of the liquid crystal molecules, in a plan view of the first substrate, the inner periphery of at least one of the first hook-like electrodes is preferably defined by at least three lines with different slopes. Also, in a plan view of the first substrate, the inner periphery of at least one of the second hook-like electrodes is preferably defined by at least three lines with different slopes. Thereby, the liquid crystal is less likely to cause alignment disorder around the end portions of the hook-like electrodes, and thus a highly uniform liquid crystal alignment can be achieved in the entire region surrounded by at least one pair of hook-like electrodes. Here, preferably, any one line of the at least three lines with different slopes included in the first hook-like electrode is in parallel with any one line of the at least three lines with different slopes included in the second hook-like electrode.

In terms of further improvement in the alignment controllability of the liquid crystal molecules, in a plan view of the first substrate, the inner periphery of at least one of the first hook-like electrodes is preferably bent. Also, in a plan view of the first substrate, the inner periphery of at least one of the second electrodes is preferably bent. Thereby, the liquid crystal is less likely to cause alignment disorder around the end portions of the hook-like electrodes, and thus a highly uniform liquid crystal alignment can be achieved in the entire region surrounded by at least one pair of hook-like electrodes.

In terms of further improvement in the alignment controllability of the liquid crystal molecules, in a plan view of the first substrate, the first hook-like electrode and the second hook-like electrode in at least one pair are preferably symmetrical about a straight line passing between the first hook-like electrode and the second hook-like electrode as an axis. Thereby, the symmetricity of the electric fields generated by at least one pair of hook-like electrodes can be improved, and thus a highly uniform liquid crystal alignment can be achieved.

In terms of further improvement in the alignment controllability of the liquid crystal molecules, in a plan view of the first substrate, the first hook-like electrode and the second hook-like electrode in at least one pair are symmetrical about a point positioned between the first hook-like electrode and the second hook-like electrode. Thereby, the symmetricity of the electric fields generated by at least one pair of hook-like electrodes can be improved, and thus a highly uniform liquid crystal alignment can be achieved.

The first hook-like electrodes and the second hook-like electrodes are preferably arranged on the same layer. Even in the case where the first hook-like electrodes and the second hook-like electrodes are formed on different layers, it is possible to produce transverse electric fields, but the electric fields partially include vertical components. This actually produces oblique electric fields. In this case, some of the liquid crystal molecules are rotated obliquely by the electric fields, which may decrease the transmittance and deteriorate the viewing angle characteristics. When the first hook-like electrodes and the second hook-like electrodes are arranged on the same layer, such an oblique electric field is less likely to be generated. Accordingly, more uniform transverse electric fields can be generated, and a decrease in the transmittance and deterioration in the viewing angle characteristics can be prevented.

Preferably, the first substrate is further provided with a first polarizer, the second substrate is further provided with a second polarizer, the polarization axis of the first polarizer and the polarization axis of the second polarizer are orthogonal to each other, in a plan view of the first substrate, the inner periphery of at least one of the first hook-like electrodes is at an angle with the polarization axis of the first polarizer and the polarization axis of the second polarizer, and in a plan view of the first substrate, the inner periphery of at least one of the second hook-like electrodes is at an angle with the polarization axis of the first polarizer and the polarization axis of the second polarizer. That is, in the present structures, the first polarizer and the second polarizer are in the crossed Nicols. Since an electric field is generated between the first hook-like electrode and the second hook-like electrode, favorable grayscale display and white display can be achieved by adjusting the axes of the polarizers at angles with the direction of the electric field.

### Advantageous Effects of Invention

The present invention can produce a liquid crystal display device capable of achieving favorable display properties even when the pixel size is small.

### BRIEF DESCRIPTION OF DRAWINGS

FIG. 1 is a schematic cross-sectional view of a liquid crystal display device of Embodiment 1 in a state where no voltage is applied.

FIG. 2 is a schematic cross-sectional view of the liquid crystal display device of Embodiment 1 in a state where white voltage is applied.

FIG. 3 is a schematic plan view of a TFT substrate in the liquid crystal display device of Embodiment 1.

FIG. 4 is a schematic plan view obtained by adding the position of a black matrix to the schematic plan view of the TFT substrate in Embodiment 1.

FIG. 5 is a schematic cross-sectional view taken along an A-B line in FIG. 3 or 14.

FIG. 6 is a schematic view illustrating the structure on the TFT substrate side of a pixel used in Example 1.

FIG. 7 is a schematic view illustrating the structure on the counter substrate side of a pixel used in Example 1.

FIG. 8 is an image showing the simulation results in Example 1 which is a cross-sectional image in a state where no voltage is applied (0 V).

FIG. 9 is an image showing the simulation results in Example 1 which is a plan view in the state where no voltage is applied (0 V).

FIG. 10 is an image showing the simulation results in Example 1 which is a cross-sectional view in a state where white voltage is applied (9.7 V).

FIG. 11 is an image showing the simulation results in Example 1 which is a plan view in the state where white voltage is applied (9.7 V).

FIG. 12 is a plan image showing the light transmittance in Example 1 in grayscale.

FIG. 13 is a graph showing the viewing angle characteristics in Example 1.

FIG. 14 is a schematic plan view of a TFT substrate in a liquid crystal display device of Embodiment 2.

FIG. 15 is a cross-sectional simulation image showing the liquid crystal molecule behavior in Example 2 in a state where white voltage is applied (8.0 V).

FIG. 16 is a plan simulation image showing the liquid crystal molecule behavior in Example 2 in the state where white voltage is applied (8.0 V).

FIG. 17 is a plan image showing the light transmittance in Example 2 in grayscale.

FIG. 18 is an image obtained by removing the black matrix from and adding the positions of electrodes to FIG. 17.

FIG. 19 is a graph showing the viewing angle characteristics in Example 2.

FIG. 20 is a schematic plan view of a TFT substrate in a liquid crystal display device of Embodiment 3.

FIG. 21 is a cross-sectional view taken along a C-D line in FIG. 20 or FIG. 27.

FIG. 22 is a cross-sectional simulation image showing the liquid crystal molecule behavior in Example 3 in a state where white voltage is applied (8.4 V).

FIG. 23 is a plan simulation image showing the liquid crystal molecule behavior in Example 3 in the state where white voltage is applied (8.4 V).

FIG. 24 is a plan view showing the light transmittance in Example 3 in grayscale.

FIG. 25 is a view obtained by removing the black matrix from and adding the positions of the electrodes to FIG. 24.

FIG. 26 is a graph showing the viewing angle characteristics in Example 3.

FIG. 27 is a schematic plan view of a TFT substrate in a liquid crystal display device of Embodiment 4.

FIG. 28 is a cross-sectional simulation image showing the liquid crystal molecule behavior in Example 4 in a state where white voltage is applied (10.5 V).

FIG. 29 is a plan simulation image showing the liquid crystal molecule behavior in Example 4 in the state where white voltage is applied (10.5 V).

FIG. 30 is a plan image showing the light transmittance in Example 4 in grayscale.

FIG. 31 is an image obtained by removing the black matrix from and adding the positions of electrodes to FIG. 30.

FIG. 32 is a graph showing the viewing angle characteristics in Example 4.

FIG. 33 is a schematic plan view of a TFT substrate in a liquid crystal display device of Embodiment 5.

FIG. 34 is a schematic cross-sectional view taken along an E-F line in FIG. 33 or FIG. 40.

FIG. 35 is a cross-sectional simulation image showing the liquid crystal molecule behavior in Example 5 in a state where white voltage is applied (8.9 V).

FIG. 36 is a plan simulation image showing the liquid crystal molecule behavior in Example 5 in the state where white voltage is applied (8.9 V).

FIG. 37 is a plan image showing the light transmittance in Example 5 in grayscale.

FIG. 38 is a plan image obtained by removing the black matrix from and adding the positions of the electrodes to FIG. 37.

FIG. 39 is a graph showing the viewing angle characteristics in Example 5.

FIG. 40 is a schematic plan view of a TFT substrate in a liquid crystal display device of Embodiment 6.

FIG. 41 is a cross-sectional simulation image showing the liquid crystal molecule behavior in Example 6 in a state where white voltage is applied (10.5 V).

FIG. 42 is a plan simulation image showing the liquid crystal molecule behavior in Example 6 in the state where white voltage is applied (10.5 V).

FIG. 43 is a plan image showing the light transmittance in Example 6 in grayscale.

FIG. 44 is a plan image obtained by removing the black matrix from and adding the positions of the electrodes to FIG. 43.

FIG. 45 is a graph showing viewing angle characteristics in Example 6.

FIG. 46 is a schematic plan view of a TFT substrate in a liquid crystal display device of Embodiment 7.

FIG. 47 is a schematic cross-sectional view taken along an E-F line in FIG. 46 or FIG. 53.

FIG. 48 is a cross-sectional simulation image showing the liquid crystal molecule behavior in Example 7 in a state where white voltage is applied (10.8 V).

FIG. 49 is a plan simulation image showing the liquid crystal molecule behavior in Example 7 in the state where white voltage is applied (10.8 V).

FIG. 50 is a plan image showing the light transmittance in Example 7 in grayscale.

FIG. 51 is a plan image obtained by removing the black matrix from and adding the positions of the electrodes to FIG. 50.

FIG. 52 is a graph showing the viewing angle characteristics in Example 7.

FIG. 53 is a schematic plan view of a TFT substrate in a liquid crystal display device of Embodiment 8.

FIG. 54 is a cross-sectional simulation image showing the liquid crystal molecule behavior in Example 8 in a state where white voltage is applied (14.0 V).

FIG. 55 is a plan simulation image showing the liquid crystal molecule behavior in Example 8 in the state where white voltage is applied (14.0 V).

FIG. 56 is a plan image showing the light transmittance in Example 8 in grayscale.

FIG. 57 is a plan image obtained by removing the black matrix from and adding the positions of the electrodes to FIG. 56.

FIG. 58 is a graph showing the viewing angle characteristics in Example 8.

FIG. 59 is a schematic plan view illustrating one example of electrode arrangement in a conventional IPS mode liquid crystal display device.

### DESCRIPTION OF EMBODIMENTS

The present invention will be described in more detail below with reference to the drawings based on embodiments which, however, are not intended to limit the scope of the present invention.

Liquid crystal display devices of the following Embodiments 1 to 8 are applicable to televisions, personal computers, cellphones, car navigation systems, and digital signage, for example.

Herein, one “pixel” is defined as a region in which the alignment of liquid crystal molecules is controlled by the following electrodes, namely a pixel electrode controlled by one switching element and a common electrode facing the pixel electrode. In the case that multiple pixel electrodes are controlled by one switching element simultaneously, one “pixel” is defined as the entire region in which the alignments of liquid crystal molecules are controlled by the respective pixel electrodes and the respective common electrodes facing the pixel electrodes.

The effects of the present invention are significant when the pixel size is small, but the concept of the present invention may also be employed when the pixel size is large due to provision of multiple electrode pairs in one pixel, for example. Here, one exemplary pixel size with which the effects of the present invention can be effectively achieved is 20 μm or shorter, or even 17 μm or shorter, for at least one side of each pixel.

Herein, an “electrode” is defined to include a component called a “conductive line”.

### Embodiment 1

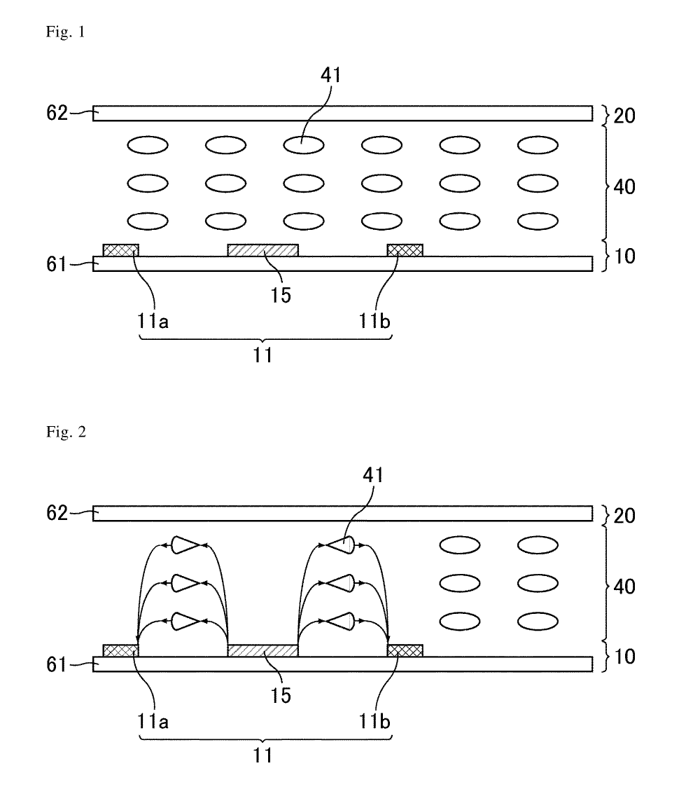

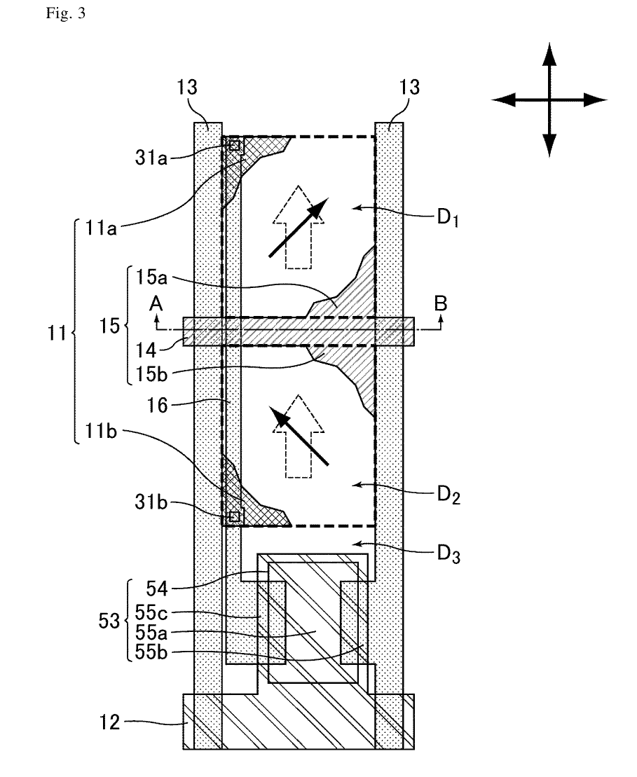

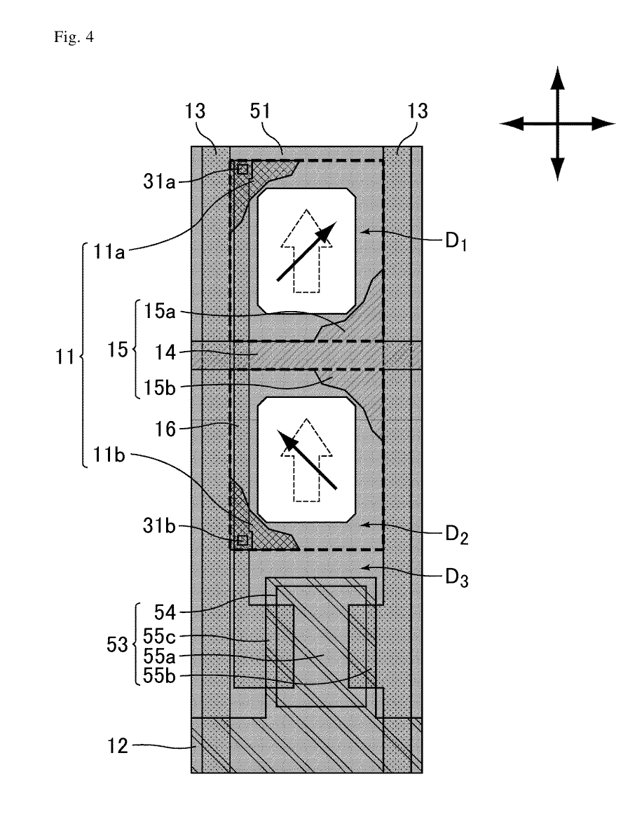

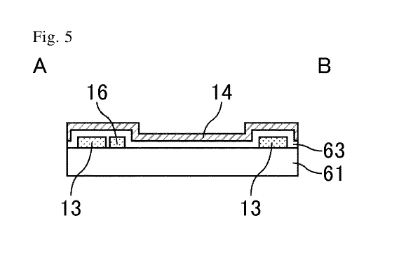

FIG. 1 and FIG. 2 are each a schematic cross-sectional view of a liquid crystal display device of Embodiment 1. FIG. 1 shows the case where no voltage is applied, and FIG. 2 shows the case where white voltage is applied. FIG. 3 and FIG. 4 are each a schematic plan view of the liquid crystal display device of Embodiment 1. FIG. 3 is a schematic plan view of a TFT substrate, and FIG. 4 is obtained by adding the position of a black matrix to the schematic plan view of the TFT substrate. FIG. 5 is a schematic cross-sectional view taken along an A-B line in FIG. 3.

The liquid crystal display device of Embodiment 1 is provided with a TFT substrate (first substrate) 10, a counter substrate (second substrate) 20, and a liquid crystal layer 40 sandwiched between the TFT substrate 10 and the counter substrate 20. The liquid crystal layer 40 contains liquid crystal molecules 41 having negative anisotropy of dielectric constant, and the liquid crystal molecules 41 are aligned in parallel with the substrates 10 and 20 both when no voltage is applied and when a voltage is applied. The TFT substrate 10 is provided with components such as a supporting substrate 61, TFTs (switching elements) 53, scanning signal lines 12, data signal lines 13, common signal lines 14, pixel electrodes (first hook-like electrodes) 11, common electrodes (second hook-like electrodes) 15, an insulating film separating the electrodes and conductive lines into different layers, and an alignment film. The counter substrate 20 is provided with components such as a supporting substrate 62, color filters, a black matrix, and an alignment film. The pixel electrodes 11 and the common electrodes 15 are independent of each other, and are supplied with signals at respective different electric potentials. Thereby, a voltage can be applied to the liquid crystal layer 40.

The pixel electrodes 11 are each further divided into a first pixel electrode 11a and a second pixel electrode 11b. The first pixel electrode 11a and the second pixel electrode 11b are arranged on the same layer. The first pixel electrode 11a and the second pixel electrode 11b are connected to each other by a pixel electrode line (first connection line) 16, and are supplied with respective image signals (pixel electric potentials) at the same electric potential. The pixel electrode line 16 is arranged on a layer that is different from the layer on which the first pixel electrode 11a and the second pixel electrode 11b are formed.

The common electrodes are each further divided into a first common electrode 15a and a second common electrode 15b. The first common electrode 15a and the second common electrode 15b are arranged on the same layer. The first common electrode 15a and the second common electrode 15b are connected to each other by a common signal line (second connection line) 14, and are supplied with respective common signals at the same electric potential. The common signal line 14 is arranged to fill the space between the first common electrode 15a and the second common electrode 15b, and thereby the first common electrode 15a, the second common electrode 15b, and the common signal line 14 are integrally formed. Hereinafter, these components are also collectively referred to simply as a common electrode portion. These components, when integrally formed as described above, more easily contribute to the aperture ratio than when formed separately.

The first pixel electrode 11a, the second pixel electrode 11b, the first common electrode 15a, and the second common electrode 15b are all arranged on the same layer. With this arrangement, electric fields with components oblique to the substrate surfaces are less likely to be formed. Thereby, a uniform transverse electric field can be formed, and a decrease in the transmittance and the viewing angle characteristics can be prevented. Components arranged as lower layers of the above components include, for example, an insulating film arranged on the supporting substrate 61. The insulating film may be formed from an organic material or an inorganic material, and may also be a single-layer film or a multi-layer film.

To the surface of the TFT substrate 10 opposite to the liquid crystal layer 40 side is bonded a polarizer (first polarizer). To the surface of the counter substrate 20 opposite to the liquid crystal layer 40 side is bonded a polarizer (second polarizer).

The first polarizer bonded to the surface of the TFT substrate 10 and the second polarizer bonded to the surface of the counter substrate 20 are arranged such that the polarization axes of the respective polarizers are orthogonal to each other. The first polarizer and the second polarizer are arranged such that the polarization axes of the respective polarizers each are at an angle with the inner periphery of each of the first pixel electrode 11a, the second pixel electrode 11b, the first common electrode 15a, and the second common electrode 15b. Furthermore, to the alignment films formed on both of the substrates, alignment treatment has been performed in the direction parallel to or perpendicular to the polarization axis of each of the first polarizer and the second polarizer. As a result, when no voltage is applied, the light passing through the liquid crystal molecules is blocked to produce black display. Also, when a voltage equal to or higher than the threshold value is applied and the voltage size thereof is further adjusted to change the alignment direction of the liquid crystal molecules, grayscale display and white display can be achieved. Here, “parallel” or “perpendicular” is not limited to being perfectly parallel or perpendicular, and includes being substantially parallel or perpendicular. Rather, performing the alignment treatment in a direction inclined by several degrees from the polarization axis of the polarizer may bring advantages such as that the alignment direction of the liquid crystal molecules can be made uniform.

As illustrated in FIG. 3, in a plan view of the TFT substrate 10 in Embodiment 1, the scanning signal line 12 and the data signal lines 13 are arranged to intersect each other. In the vicinity of the intersection of the scanning signal line 12 and the data signal lines 13, the thin-film transistor (TFT) 53 is provided. Between one scanning signal line 12 and another scanning signal line 12, the common signal line 14 extending in parallel with the scanning signal lines 12 is formed. The initial alignment of the liquid crystal molecules 41 is parallel to the extension direction of the data signal lines 13 and orthogonal to the extension direction of the scanning signal line 12 and the common signal line 14. Both of the arrows in FIG. 3 indicate the directions of the polarization axes of the polarizers.

As illustrated in FIG. 5, the data signal lines 13 and the pixel electrode line 16 are formed on the supporting substrate 61. In such an arrangement as in the present embodiment, the data signal lines 13 and the pixel electrode line 16 can also be simultaneously formed from the same conductive line material. On the data signal lines 13, the pixel electrode line 16, and the supporting substrate 61, a first insulating layer 63 is formed. On the first insulating film 63, a common signal line 14 is arranged.

The TFTs 53 are switching elements each including a semiconductor layer 54, a gate electrode 55a, a source electrode 55b, and a drain electrode 55c. The gate electrode 55a includes part of the scanning signal line 12. The source electrode 55b is branched from one data signal line 13. The gate electrode 55a and the semiconductor layer 54 overlap each other with a gate insulating layer in between. The source electrode 55b is connected to the drain electrode 55c via the semiconductor layer 54. From the drain electrode 55c, a pixel electrode line 16 is led out. The first pixel electrode 11a and the second pixel electrode 11b are respectively connected to the pixel electrode line 16 contact portions 31a and 31b penetrating the first insulating film 63. By scanning signals input into the gate electrode 55a via the scanning signal line 12, the amount of current flowing through the semiconductor layer 54 is controlled. Through the data signal line 13, input image signals are controlled to be transferred in the order of the source electrode 55b, the semiconductor layer 54, the drain electrode 55c, the pixel electrode line 16, and the first pixel electrode 11a or the second pixel electrode 11b.

As illustrated in FIG. 3, the first pixel electrode 11a and the second pixel electrode 11b each have a hook-like shape, and each electrode itself is symmetrical about a certain axis. The first pixel electrode 11a and the second pixel electrode 11b each have a sharp tip at an end portion. Also, the inner periphery of each of the first pixel electrode 11a and the second pixel electrode 11b is defined by at least three lines (in FIG. 3, five lines) with different slopes, and the central line of the at least three lines is orthogonal to the bisector (line of symmetry) of the electrode.

As illustrated in FIG. 3, the first common electrode 15a and the second common electrode 15b each have a hook-like shape, and each electrode itself is symmetrical about a certain axis. The first common electrode 15a and the second common electrode 15b each have a sharp tip at an end portion. Also, the inner periphery of each of the first common electrode 15a and the second common electrode 15b is defined by at least three lines (in FIG. 3, five lines) with different slopes, and the central line of the at least three lines is orthogonal to the bisector (line of symmetry) of the electrode.

As illustrated in FIG. 3, the inner periphery of the first pixel electrode 11a and the inner periphery of the first common electrode 15a face each other, and are partially parallel to each other. Also, the inner periphery of the second pixel electrode 11b and the inner periphery of the second common electrode 15b face each other, and are partially parallel to each other. In Embodiment 1, the shape of the inner periphery is important in controlling the alignment of liquid crystal molecules, and the shape of the outer periphery is not particularly limited.

The first common electrode 15a and the second common electrode 15b are arranged symmetrically about the common signal line 14 arranged between these electrodes. The common signal line 14 is formed to be straight irrespectively of the borders of the pixels. That is, the common signal line 14 is extended to pass through the pixels, and one common signal line 14 supplies the same common signal to the common electrodes 15a and 15b included in the respective adjacent pixels arranged in the same direction as the extension direction of the common signal line 14.

The pixel electrode line 16 connecting the first pixel electrode 11a and the second pixel electrode 11b is formed in parallel with the data signal lines 13. That is, the pixel electrode line 16 is formed to intersect the common signal line 14.

As described above, the first pixel electrode 11a, the second pixel electrode 11b, the first common electrode 15a, and the second common electrode 15b are all arranged on the same layer. Also, the first common electrode 15a, the second common electrode 15b, and the common signal line 14 are all arranged on the same layer. The pixel electrode line 16 connecting the first pixel electrode 11a and the second pixel electrode 11b is arranged on a different layer from these electrodes. It is therefore possible to prevent the pixel electrodes 11a and 11b from being electrically connected to the common electrodes 15a and 15b.

As illustrated in FIG. 3, a combination of the first pixel electrode 11a and the first common electrode 15a and a combination of the second pixel electrode 11b and the second common electrode 15b are each an electrode pair. Such electrode pairs are arranged on the TFT substrate 10.

The first pixel electrode 11a and the first common electrode 15a in combination are symmetrical about a straight line passing between the electrodes 11a and 15a as an axis, and are symmetrical about a point positioned between the electrodes 11a and 15a as the center.

The second pixel electrode 11b and the second common electrode 15b in combination are symmetrical about a straight line passing between the electrodes 11b and 15b as an axis, and are symmetrical about a point positioned between the electrodes 11b and 15b as the center.

The first pixel electrode 11a, the second pixel electrode 11b, the first common electrode 15a, and the second common electrode 15b in these electrode pairs are arranged such that the electrode pairs are symmetrical about a straight line passing between the first pixel electrode 11a and the second pixel electrode 11b as the reference axis. In Embodiment 1, the first pixel electrode 11a, the second pixel electrode 11b, the first common electrode 15a, and the second common electrode 15b are the same in size and are different in shape of the inner periphery or in direction.

The length from one end to the other end (the length of the inner periphery) of each of the first pixel electrode 11a, the second pixel electrode 11b, the first common electrode 15a, and the second common electrode 15b depends on the designed pixel size, but is in the range of 10 to 20 μm, for example. Also, the width of each of the first pixel electrode 11a, the second pixel electrode 11b, the first common electrode 15a, and the second common electrode 15b depends on the designed size and position of the pixels, and is 2 μm for the maximum portion, for example.

As illustrated in FIG. 3, each pixel includes a region (hereinafter, also referred to as a first divisional region D1) surrounded by the outer periphery of the first pixel electrode 11a, an extended line from each end of the first pixel electrode 11a, the outer periphery of the first common electrode 15a, and an extended line from each end of the first common electrode 15a; and a region (hereinafter, also referred to as a second divisional region D2) surrounded by the outer periphery of the second pixel electrode 11b, an extended line from each end of the second pixel electrode 11b, the outer periphery of the second common electrode 15b, and an extended line from each end of the second common electrode 15b. Also, the region (hereinafter, also referred to as an empty region D3) positioned on the lower side of the figure than the first divisional region D1 and the second divisional region D2 is part of the pixel. In the example shown in FIG. 3, the area of the empty region D3 is about the same as the areas of the first divisional region D1 and the second divisional region D2, but is not particularly limited and can be reduced if necessary.

FIG. 3 shows an embodiment in which the first pixel electrode 11a is positioned at the upper left of the first divisional region D1, the first common electrode 15a is positioned at the lower right of the first divisional region D1, the second pixel electrode 11b is positioned at the lower left of the second divisional region D2, and the second common electrode 15b is positioned at the upper right of the second divisional region D2. Here, the pixel electrode and the common electrode may be at any positions where the inner peripheries of the electrodes face each other.

The scanning signal line 12 is formed in the empty region D3 positioned on the lower side of the figure than the pixel electrodes 11a and 11b and the common electrodes 15a and 15b. The scanning signal line 12 is also formed to be straight irrespectively of the borders of the pixels. That is, the scanning signal line 12 is extended to pass through the pixels, and one scanning signal line 12 supplies the same scanning signal to the TFTs included in the respective adjacent pixels arranged in the same direction as the extension direction of the scanning signal line 12. In Embodiment 1, the position of the scanning signal line 12 is not particularly limited, and thus the scanning signal line 12 can be arranged with a high degree of freedom.

The TFT 53 is formed in the empty region D3 positioned on the lower side of the figure than the pixel electrodes 11a and 11b and the common electrodes 15a and 15b. In Embodiment 1, the position of the TFT 53 is not particularly limited, and thus the TFT 53 can be arranged with a high degree of freedom. Furthermore, as described later, when an oxide semiconductor such as IGZO is used as the material of the semiconductor layer 54 of the TFT 53, the size of the TFT 53 as a whole can be reduced.

As illustrated in FIG. 4, the black matrix 51 is provided with openings correspondingly to the regions in which the alignment of the liquid crystal molecules is controlled by the electrodes. That is, the black matrix 51 is formed such that the outer edge of each opening is formed along the first divisional region D1 and the second divisional region D2. As a result, the black matrix 51 is in a lattice form as a whole. The empty region D3 is covered with the black matrix 51. The openings surrounded by the black matrix 51 function as regions that transmit display light.

As illustrated in FIG. 4, the four corners of each opening of the black matrix 51 are cut. Specifically, each corner of the openings in the black matrix 51 has a potion parallel to the inner periphery of the nearby first pixel electrode 11a, first common electrode 15a, second pixel electrode 11b, or second common electrode 15b. In other words, the shape of each opening is a polygon formed by chamfering the corners of a square.

In the example shown in FIG. 4, the openings in the black matrix 51 are formed to be slightly smaller than the first divisional region D1 and the second divisional region D2. Preferably, the length of one side of the first divisional region D1 and the second divisional region D2 is 100% to 110% of the length of one side of openings formed along the regions.

As illustrated in FIG. 3 and FIG. 4, the liquid crystal molecules 41 are aligned at an angle with the bisector of each of the first pixel electrode 11a, the second pixel electrode 11b, the first common electrode 15a, and the second common electrode 15b when no voltage is applied. The hollow dotted arrows in FIG. 3 and FIG. 4 each indicate the alignment direction (the long axis direction) of the liquid crystal molecules with no voltage applied.

Meanwhile, as illustrated in FIG. 3 and FIG. 4, the liquid crystal molecules are aligned in the direction parallel to or perpendicular to the bisector of each of the first pixel electrode 11a, the second pixel electrode 11b, the first common electrode 15a, and the second common electrode when white voltage is applied. The solid black arrows in FIG. 3 and FIG. 4 each indicate the alignment direction (the long axis direction) of the liquid crystal molecules with white voltage applied.

In Embodiment 1, the first divisional region D1 and the second divisional region D2 have a rectangular or square shape as a whole. Thereby, an excellent transmittance and a wide viewing angle can be achieved.

Furthermore, in Embodiment 1, the following conditions contribute to an excellent transmittance and a wide viewing angle. (i) An end portion of each electrode has a sharp tip. (ii) Each electrode has a shape that is symmetrical about a certain axis as a reference. (iii) The inner periphery of each electrode is defined by at least three lines with different slopes, and the central line of the at least three lines is orthogonal to the bisector of the electrode. (iv) A pixel electrode and a common electrode in combination are symmetrical (specifically, about a line or a point). (v) The electrode pair constituting the first divisional region D1 and the electrode pair constituting the second divisional region D2 are symmetrical (specifically, about a line). (vi) The sizes of the respective electrodes constituting one pixel are the same.

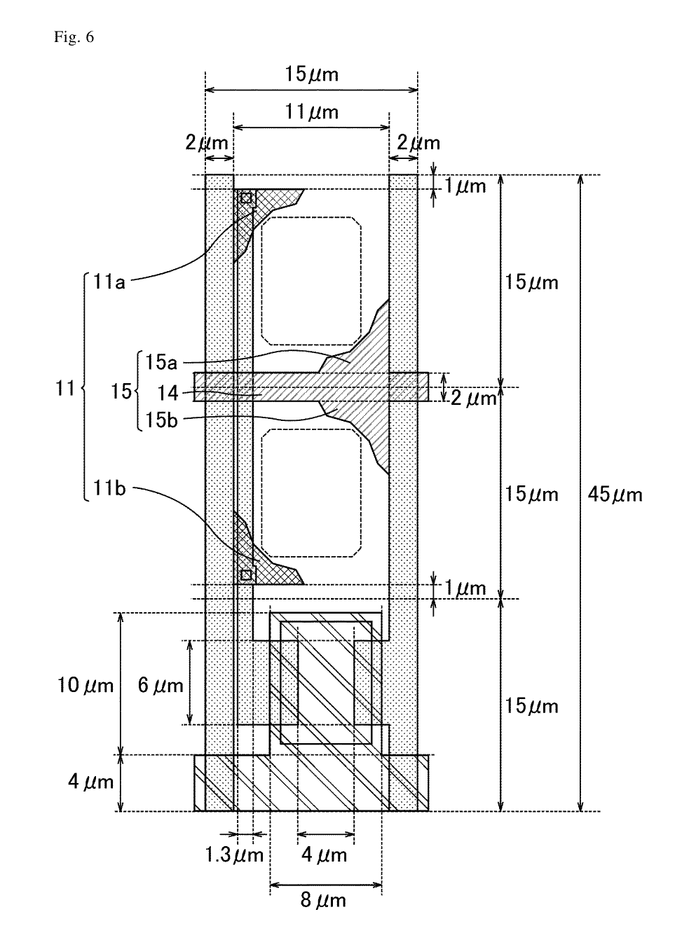

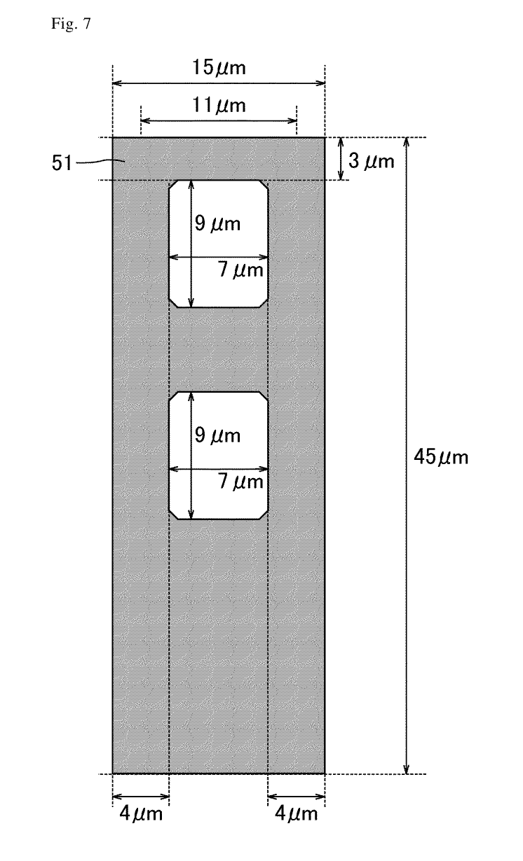

Specific simulation with the liquid crystal display device of Embodiment 1 showed the following results (Example 1). FIG. 6 and FIG. 7 are schematic views illustrating the structure of pixels in Example 1. FIG. 6 illustrates the TFT substrate side, and FIG. 7 illustrates the counter substrate side. The conditions of the simulation in Example 1 were set as described below. The anisotropy of dielectric constant of the liquid crystal material was negative (Δ∈=−7). The pixel size was 15 μm×45 μm. The inner periphery of each of the pixel electrodes and the common electrodes was defined by five lines with different slopes, and the angles formed by the adjacent lines were all obtuse angles. Thereby, the regions in which the electric fields are locally generated can be eliminated. More specifically, the central line of the five lines (hereinafter, the central line is also referred to as the inner periphery of the corner portion) and the line positioned at each side of the central line form an angle of 152°. The distance between the pixel electrode and the common electrode (specifically, the length of the straight line connecting the innermost portion of the corner portion of the pixel electrode and the innermost portion of the corner portion of the common electrode) was 10.1 μm. From the outer periphery of a pixel to the outer periphery of each electrode, a space of 2 μm was provided. The length of each long side of the first divisional region D1 and the second divisional region D2 was set to 13 μm, and the length of each shorter side thereof was set to 11 μm. Hence, the aspect ratio of each of the divisional regions D1 and D2 is 13:11. Also, the size of each opening of the black matrix is 9 μm×7 μm, and each of the four corners of the opening was chamfered to remove an isosceles right triangle with a base of 1 μm. That is, the aspect ratio of each opening of the black matrix is 9:7.

When the pixel electrode and the common electrode are hook-like shaped and are arranged near the corners of each opening of the black matrix to surround the opening with a certain space in between, the direction of the electric field can be controlled to the desired direction while generation of local electric fields is prevented in a virtual region surrounded by the pixel electrode, the common electrode, and lines defined by connecting the tips of the end portions of the electrodes. Furthermore, when the slope of the inner periphery of each of the pixel electrode and the common electrode is gradually changed, the ratio of change in the direction of the electric fields is reduced, and thereby generation of alignment disorder of the liquid crystal can be suppressed.

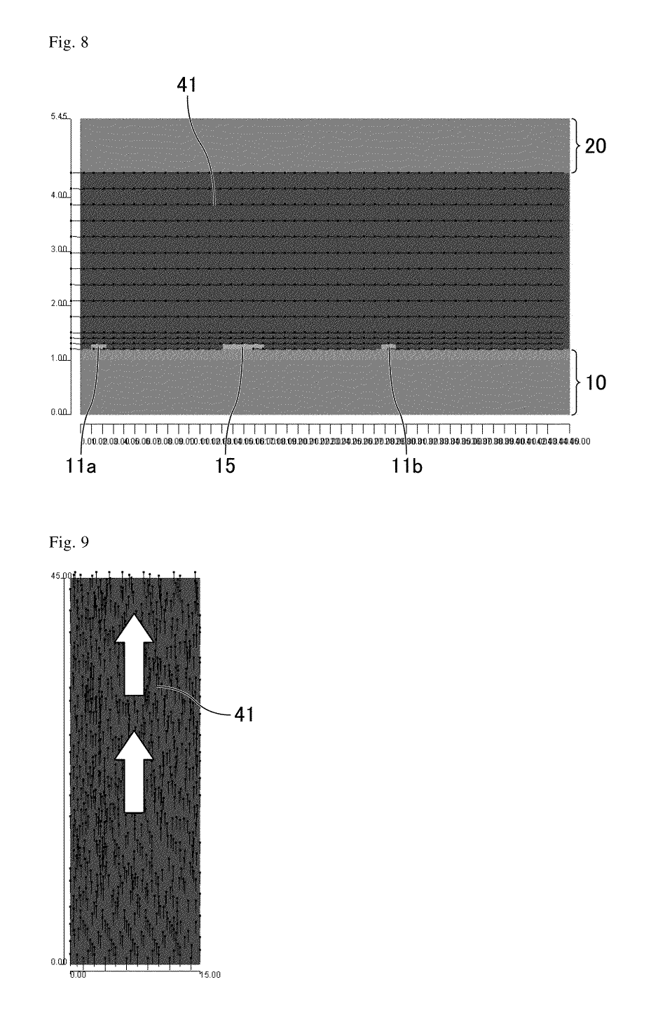

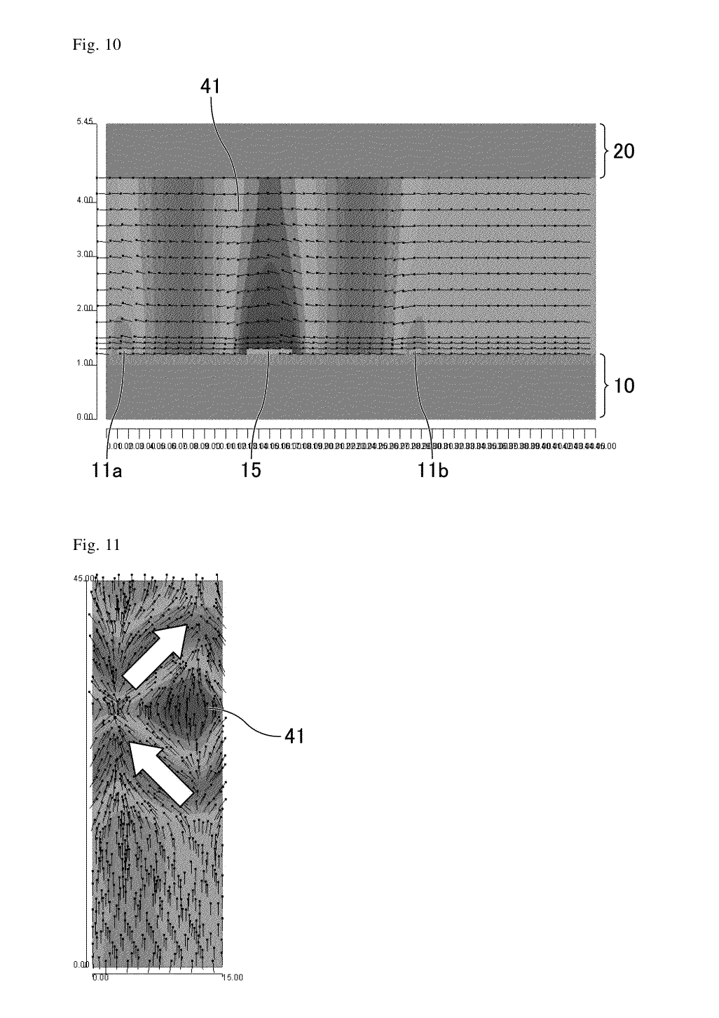

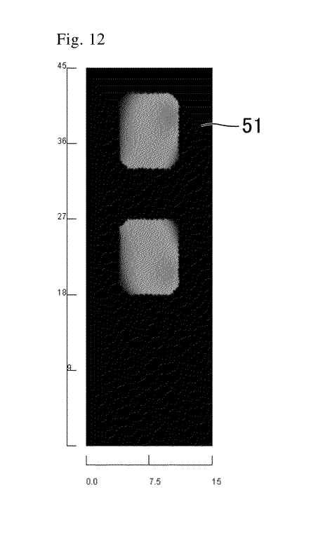

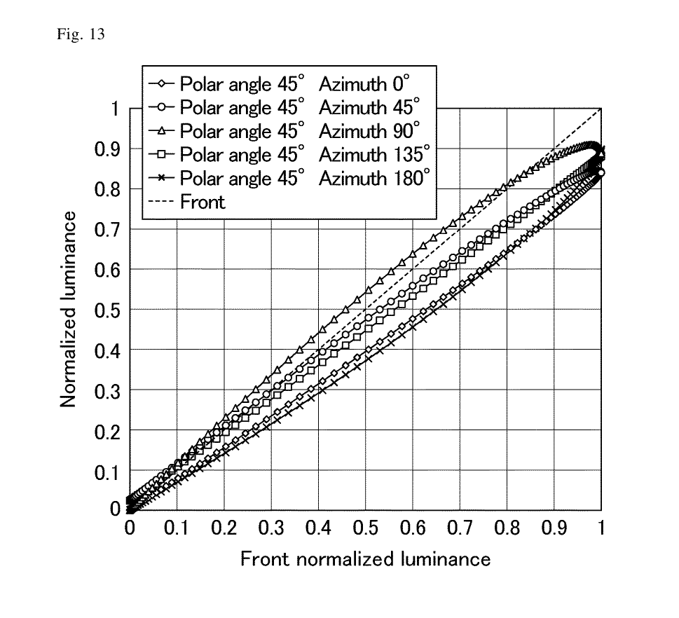

FIG. 8 to FIG. 13 are each an image or graph which shows the simulation results of Example 1. The liquid crystal material used is one that has negative anisotropy of dielectric constant. FIG. 8 and FIG. 9 each show the state where no voltage is applied (0 V), and FIG. 10 and FIG. 11 each show the state where white voltage is applied (9.7 V). FIG. 8 and FIG. 10 are each a cross-sectional image, and FIG. 9 and FIG. 11 are each a plan image. FIG. 12 is a plan image showing the light transmittance in Example 1 in grayscale. FIG. 13 is a graph showing the viewing angle characteristics in Example 1, which shows the luminance values at various azimuths with the polar angle fixed at 45° from the display screen taken as the reference surface.

As shown in FIG. 8 and FIG. 9, when no voltage is applied, the liquid crystal molecules 41 are uniformly aligned in the long side direction of the pixel. Meanwhile, as illustrated in FIG. 10 and FIG. 11, when a voltage equal to or higher than the threshold voltage is applied, the initial alignment of the liquid crystal molecules 41 is maintained in the vicinity of the TFT substrate 10, but in the other parts, the alignment of the liquid crystal molecules 41 changes. In particular, the liquid crystal molecules 41 positioned between the pixel electrodes 11a and 11b and the common electrodes 15a and 15b facing the pixel electrodes are aligned in the direction oblique to the long sides of the pixels, though the angles thereof are different depending on the distances from the electrodes. In FIG. 10 and FIG. 11, the regions are shown in gradation that reflects the strengths of the electric fields.

When a voltage is applied between the pixel electrodes 11 and the common electrodes 15, electric lines of force are generated from the common electrodes 15 to the pixel electrodes 11. Each electric line of force is generated as an almost straight line in a range surrounded by extended lines connecting the ends of the electrodes. Hence, an electric field with excellent uniformity is formed, and the liquid crystal molecules are aligned according to the electric field. Most of the liquid crystal molecules in the first divisional region D1 are aligned to be orthogonal to the inner periphery of each electrode, i.e., aligned at about 45° from the initial alignment, though the angles are different depending on the regions. Here, the change in the angle is smooth and uniform. Similarly, most of the liquid crystal molecules in the second divisional region D2 are aligned to be orthogonal to the inner periphery of each electrode, i.e., aligned at about 45° from the initial alignment, though the angles are different depending on the regions. Here, too, the change in the angle is smooth and uniform.

Furthermore, the characteristic configuration here is that the alignment distribution (director distribution) of these liquid crystal molecules 41 is symmetrical about a straight line passing between the first common electrode 15a and the second common electrode 15b, i.e., the common signal line 14, as an axis. Another characteristic is that even when the initial alignment direction is a certain one direction, different alignment directions are naturally generated in a region corresponding one pixel in the liquid crystal layer. Thereby, two regions (a multi-domain) in which the respective alignment patterns of the liquid crystal molecules are symmetrical about a certain reference axis can be formed.

As described above, the structure of Embodiment 1 can give uniform alignment to the liquid crystal molecules in the portion used as the display region, and can further form two regions with the respective different alignment directions. Hence, the light can be efficiently utilized, and excellent viewing angle characteristics can be obtained. The structure in Embodiment 1 can also achieve an excellent effect that the characteristics do not decrease even when the pixel size is designed to be small.

As shown in FIG. 12, light is uniformly transmitted in the entire region of the openings in the black matrix 51, which means that a high transmittance is maintained. Also, as shown in FIG. 13, the luminance values are not much different at any angles, and the ends of the curves are converged to the same portion, which means that the appearance does not change at any viewing angle, and that excellent viewing angle characteristics can be achieved.

In Embodiment 1, the aspect ratios of the first divisional region D1 and the second divisional region D2 and the aspect ratio of the black matrix 51 are not necessarily the same. The shape of the openings in the black matrix 51 is not limited to a rectangle or a square, and may be determined in consideration of the region suitable for display. Also, the relation between the sizes of the first divisional region D1 and the second divisional region D2 and the size of the openings in the black matrix 51 is not particularly limited.

Hereinafter, the materials and production methods of the other components are described.

For the materials of the supporting substrates 61 and 62, a transparent material such as glass and plastic is suitable. For the material of the insulating films (e.g. first insulating layer 63 and second insulating layer 64), a transparent material such as silicon nitride, silicon oxide, and a photosensitive acrylate resin is suitable. Also, in place of these insulating films, color filters may be arranged. An insulating film is formed by, for example, performing a plasma enhanced chemical vapor deposition (PECVD) method on a silicon nitride film, and forming a photosensitive acrylic resin film on the silicon nitride film by the die coating (application) method. The holes formed in each insulating film for formation of contact portions 31a, 31b, and 31c can be formed by dry etching (channel etching).

The scanning signal lines 12, the data signal lines 13, the common signal lines 14, the pixel electrode lines 16, and the various electrodes constituting the TFTs 53 can be formed by forming a single-layer or multi-layer film from a metal (e.g. titanium, chromium, aluminum, molybdenum) or an alloy thereof by a method such as sputtering, and patterning the film by a method such as photolithography. When these various conductive lines and electrodes are formed on the same layer, they can be efficiently produced from the same material. The common signal lines 14 may be formed from the same material as, for example, the common electrodes 15 when the common signal lines 14 are integrally formed with the common electrodes 15, which increases the production efficiency. Similarly, the pixel electrode lines 16 may be formed from the same material as, for example, the pixel electrodes 11 when the pixel electrode lines 16 are integrally formed with the pixel electrodes 11, which increases the production efficiency.

The semiconductor layer 54 of each TFT 53 can be, for example, a laminate of a high-resistant semiconductor layer (i layer) made of a material such as amorphous silicon and polysilicon and a low-resistant semiconductor layer (n⁺ layer) made of a material such as n⁺ amorphous silicon obtained by doping amorphous silicon with an impurity such as phosphorous. The other suitable materials include an oxide semiconductor such as indium gallium zinc oxide (IGZO).

When an oxide semiconductor such as IGZO is used as a material of the semiconductor layer 54, high electron mobility can be achieved, and the size of the TFTs 53 can be reduced. Thereby, a high aperture ratio can be achieved. An oxide semiconductor of IGZO is advantageous when the pixel size is reduced. Also, since such an oxide semiconductor has low off-leakage characteristics, the electric charge can be held for a long time, and low frequency driving can be achieved.

The pixel electrodes 11 and the common electrodes 15 can each be formed by a single-layer or multi-layer film of a transparent conductive material such as indium tin oxide (ITO), indium zinc oxide (IZO), zinc oxide (ZnO), and tin oxide (SnO), or an alloy thereof by a method such as sputtering, and then patterning the film by a method such as photolithography.

Suitable materials for color filters include photosensitive resins (color resists) that transmit light rays corresponding to the respective colors. The black matrix 51 may be formed from any material that has a light-shielding property, and a resin material containing a black pigment or a metal material having a light-shielding property is suitable. The color filters and the black matrix 51 may be formed on the TFT substrate 10, not on the counter substrate 20.

On one of the TFT substrate 10 and the counter substrate 20 produced as described above, pillar-shaped spacers made of an insulating material are arranged, and then the substrates are bonded to each other with a sealing material. The liquid crystal layer 40 is formed between the TFT substrate 10 and the counter substrate 20. Here, in the case of employing one drop filling, the liquid crystal material is dropped before the substrates are bonded, and in the case of employing vacuum injection, the liquid crystal material is injected between the substrates after the substrates are bonded.

To the surface of each substrate on the side opposite to the liquid crystal layer 40 side, components such as polarizers and a phase difference film are bonded, so that a liquid crystal display device is completed. When components such as a gate driver, a source driver, and a display control circuit are mounted on the liquid crystal display device and the liquid crystal display device is combined with a component such as a backlight, a liquid crystal display device suited for the use is completed.

### Embodiment 2

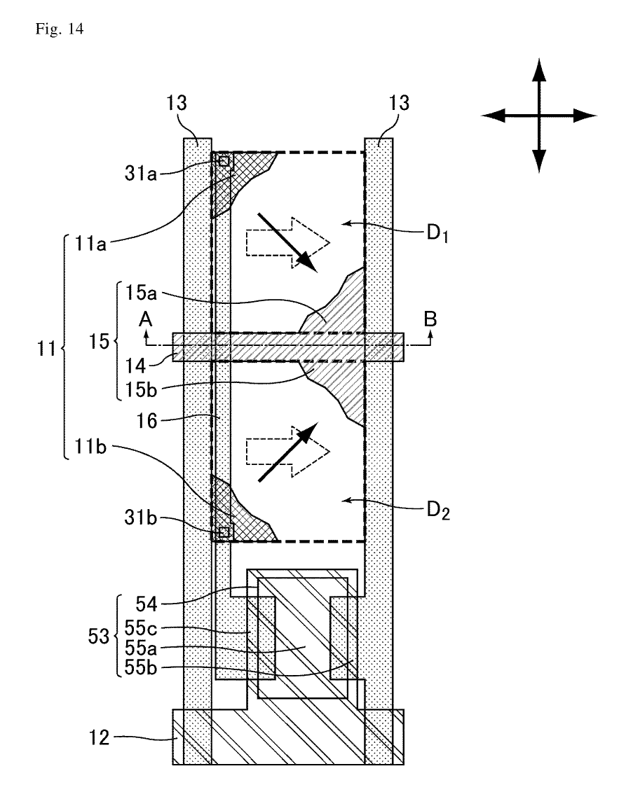

Embodiment 2 is the same as Embodiment 1, except that the initial alignment directions of the liquid crystal molecules are different, the anisotropies of dielectric constant of the liquid crystal materials are different, and the shapes of the pixel electrodes and the common electrodes are different. More specifically, the initial alignment direction of the liquid crystal molecules in Embodiment 2 is set to be parallel to the extension direction of the scanning signal line and common signal line. Here, the anisotropy of dielectric constant of the liquid crystal material is positive. FIG. 14 is a schematic plan view of a TFT substrate in the liquid crystal display device of Embodiment 2. A cross-sectional view taken along the A-B line in FIG. 14 is the same as FIG. 5.

Specific simulation with the liquid crystal display device of Embodiment 2 showed the following results (Example 2). The conditions of the simulation in Example 2 are the same as those of the simulation in Example 1, except for the initial alignment direction of the liquid crystal molecules, the anisotropy of dielectric constant of the liquid crystal material, and the shapes of the electrodes. In Example 2, the initial alignment is 90° different from that in Example 1. That is, the initial alignment in Example 1 was set to the upward direction, but the initial alignment in Example 2 is set to the rightward direction. That is, in Example 2, the initial alignment direction of the liquid crystal molecules 41 is in parallel with the extension direction of the scanning signal line 12 and the common signal line 14, and is orthogonal to the extension direction of the data signal lines 13. Here, the anisotropy of dielectric constant of the liquid crystal material was positive (Δ∈=+10). As to the shapes of the electrodes, the length of each end of each electrode and the length of the inner periphery of each corner portion were shorter than those in Example 1. The inner periphery of each of the pixel electrodes and the common electrodes was defined by five lines with different slopes, and the angles formed by the adjacent lines were all obtuse angles. More specifically, the central line of the five lines (hereinafter, the central line is also referred to as the inner periphery of the corner portion) and the line positioned at each side of the central line form an angle of 157°. The distance between the pixel electrode and the common electrode (specifically, the length of the straight line connecting the innermost portion of the corner portion of the pixel electrode and the innermost portion of the corner portion of the common electrode) was 10.1 μm. In this manner, the optimal shape of the electrodes is different depending on the initial alignment direction of the liquid crystal molecules and the anisotropy of dielectric constant of the liquid crystal material.

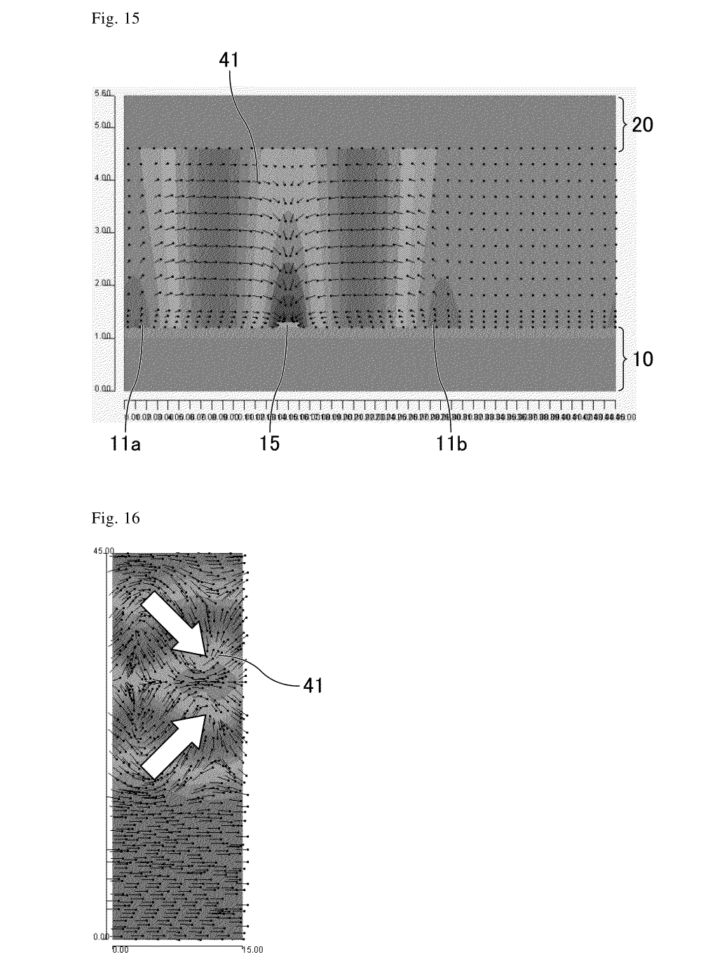

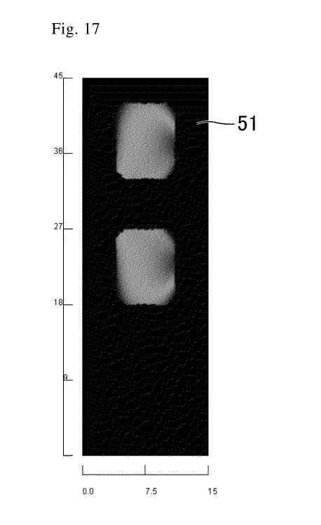

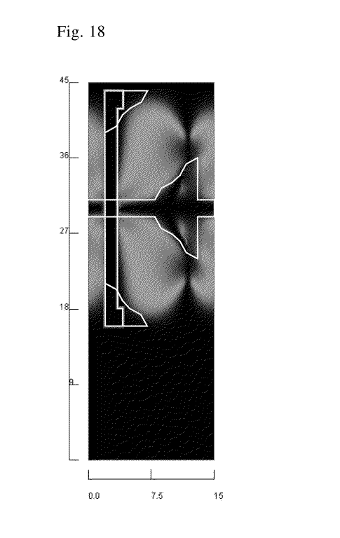

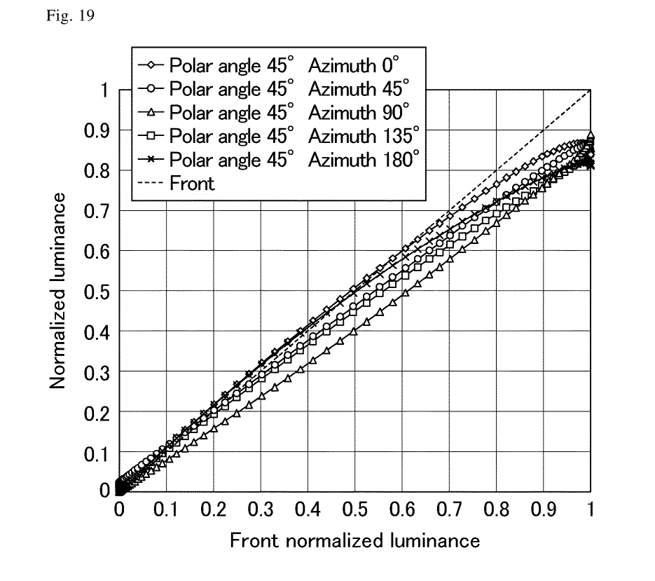

FIG. 15 and FIG. 16 are each a simulation image showing the liquid crystal molecule behavior in Example 2 in a state where white voltage is applied (8.0 V). FIG. 15 is a cross-sectional view, and FIG. 16 is a plan view. FIG. 17 is a plan image showing the light transmittance in Example 2 in grayscale. FIG. 18 is a view obtained by removing the black matrix from and adding the positions of electrodes to FIG. 17. FIG. 19 is a graph showing the viewing angle characteristics in Example 2, which shows the luminance values at various azimuths with the polar angle fixed at 45° from the display screen taken as the reference surface.

As shown in FIG. 15 and FIG. 16, when a voltage equal to or higher than the threshold voltage is applied, the initial alignment of the liquid crystal molecules 41 is maintained in the vicinity of the TFT substrate 10, but in the other parts, the alignment of the liquid crystal molecules 41 changes. In particular, the liquid crystal molecules 41 positioned between the pixel electrodes 11a and 11b and the common electrodes 15a and 15b facing the pixel electrodes are aligned in the direction oblique to the long sides of the pixels, though the angles thereof are different depending on the distances from the electrodes. In FIG. 15 and FIG. 16, the regions are shown in gradation that reflects the strengths of the electric fields.

As shown in FIG. 16, the alignment distribution (director distribution) of these liquid crystal molecules 41 is symmetrical about a straight line passing between the first common electrode 15a and the second common electrode 15b, i.e., the common signal line 14, as an axis. Thereby, in a region corresponding to one pixel in the liquid crystal layer, two regions (a multi-domain) in which the respective alignment directions are different and the respective alignment patterns of the liquid crystal molecules are symmetrical about a certain reference axis can be formed.

Comparison between the results of Example 1 and the results of Example 2 shows that even when the initial alignment directions and the anisotropies of dielectric constant of the liquid crystal materials are different, the same characteristics can be achieved by providing the desired shapes to the pixel electrodes and common electrodes. Also, since two electrode pairs each consisting of a pixel electrode and a common electrode are used, two regions with the respective different alignment directions can be formed. Thereby, the light can be efficiently utilized and excellent viewing angle characteristics can be achieved. Furthermore, an excellent effect of preventing deterioration of the characteristics even when the pixel size is small can be achieved.

As shown in FIG. 17, light is uniformly transmitted in the entire region of the openings in the black matrix 51, which means that a high transmittance is maintained. Also, as shown in FIG. 18, even without consideration of the black matrix, a transmissive region that is sufficiently large and occupies a certain range is formed. As shown in FIG. 19, the luminance values are not much different at any angles as in the case of Example 1 even though the patterns are different, and the ends of the curves are converged to the same portion, which means that the appearance does not change at any viewing angle, and that excellent viewing angle characteristics can be achieved.

Hence, Embodiment 2 shows that an excellent transmittance and excellent viewing angle characteristics can be achieved.

### Embodiment 3

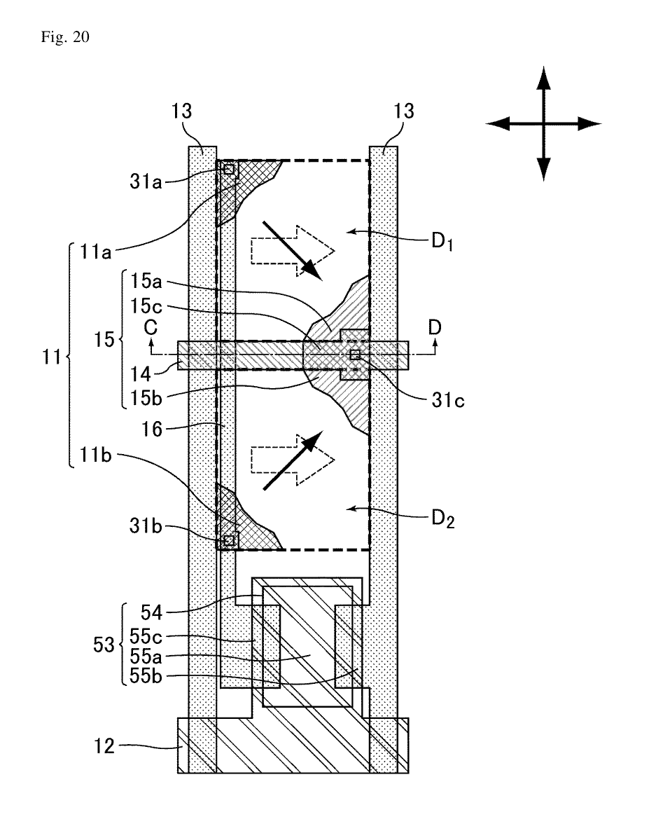

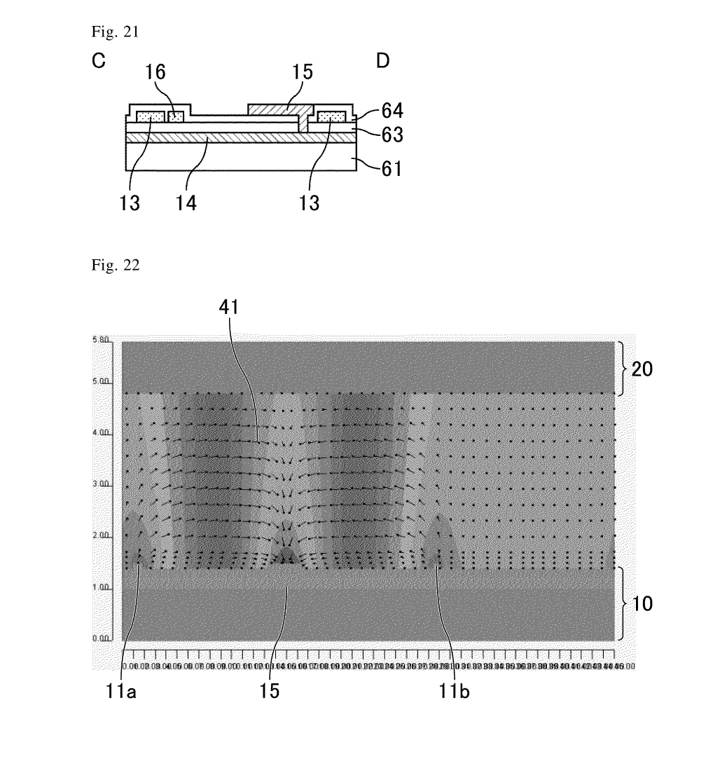

Embodiment 3 is the same as Embodiment 2, except that the shapes of the common electrodes are different, and the pixel electrodes, the common electrodes, and the common signal lines are arranged on different layers. FIG. 20 is a schematic plan view of a TFT substrate in a liquid crystal display device of Embodiment 3. FIG. 21 is a cross-sectional view taken along the C-D line in FIG. 20.

As illustrated in FIG. 21, the common signal line 14 is formed on the supporting substrate 61. On the common signal line 14 and the supporting substrate 61, a first insulating film 63 is formed. On the first insulating film 63, the data signal lines 13 and the pixel electrode line 16 are arranged. On the data signal lines 13 and the pixel electrode line 16, a second insulating film 64 is formed. On the second insulating film 64, the common electrode 15 is arranged.

Since the common electrode 15 and the common signal line 14 are arranged on different layers, the first common electrode 15a and the second common electrode 15b are connected to each other via a connection electrode (second connection line) 15c arranged between the first common electrode 15a and the second common electrode 15b, not via the common signal line 14. That is, the first common electrode 15a, the second common electrode 15b, and the connection electrode 15c are integrally formed and constitute a common electrode portion. The common signal line 14 and the connection electrode 15c are connected to each other via the contact portion 31c penetrating the first insulating film 63 and the second insulating film 64. Thereby, common signals can be transmitted from the common signal line 14 to the first common electrode 15a and the second common electrode 15b via the connection electrode 15c.

In Embodiment 3, due to the arrangement of the electrodes and the conductive lines on different layers, the surface of the TFT substrate 10 is likely to be uneven compared to that in Embodiments 1 and 2.

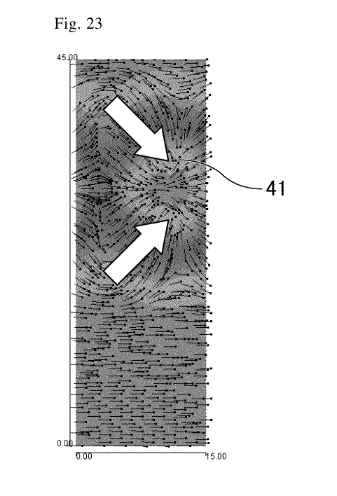

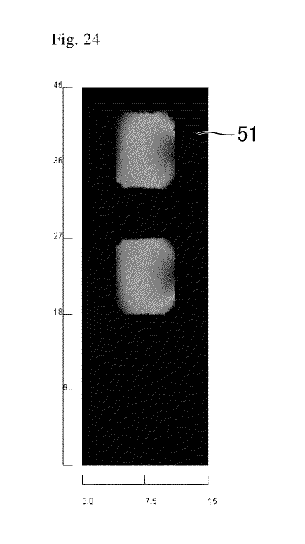

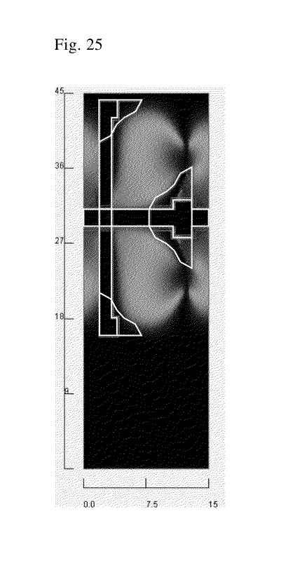

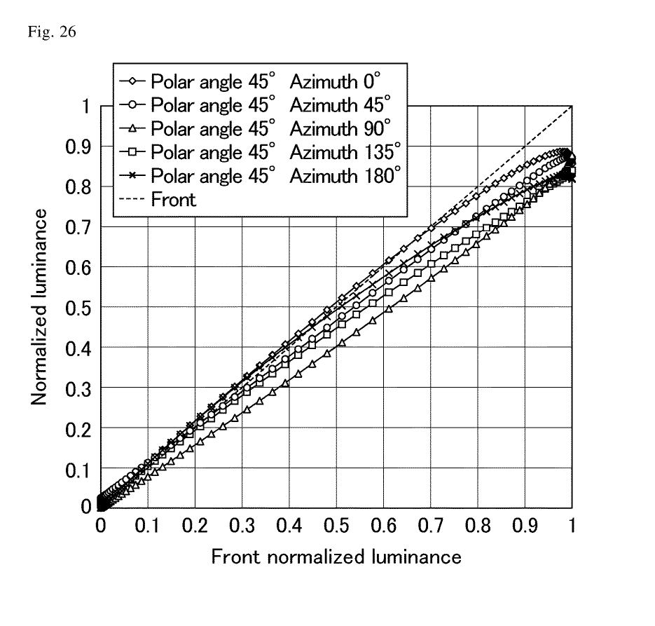

Specific simulation with the liquid crystal display device of Embodiment 3 showed the following results (Example 3). The conditions of the simulation in Example 3 are the same as those of the simulation in Example 2, except that the shapes of the common electrodes are different, and the pixel electrodes, the common electrodes, and the common signal lines are arranged on different layers. FIG. 22 and FIG. 23 are each a simulation image showing the liquid crystal molecule behavior in Example 3 in a state where white voltage is applied (8.4 V; increased by 0.4 V compared to Example 2). FIG. 22 is a cross-sectional view, and FIG. 23 is a plan view. FIG. 24 is a plan image showing the light transmittance in Example 3 in grayscale. FIG. 25 is a view obtained by removing the black matrix from and adding the positions of the electrodes to FIG. 24. FIG. 26 is a graph showing the viewing angle characteristics in Example 3, which shows the luminance values at various azimuths with the polar angle fixed at 45° from the display screen taken as the reference surface.

As shown in FIG. 22 and FIG. 23, when a voltage equal to or higher than the threshold voltage is applied, the initial alignment of the liquid crystal molecules 41 is maintained in the vicinity of the TFT substrate 10, but in the other parts, the alignment of the liquid crystal molecules 41 changes. In particular, the liquid crystal molecules 41 positioned between the pixel electrodes 11a and 11b and the common electrodes 15a and 15b facing the pixel electrodes are aligned in the direction oblique to the long sides of the pixels, though the angles thereof are different depending on the distances from the electrodes. In FIG. 22 and FIG. 23, the regions are shown in gradation that reflects the strengths of the electric fields.

As shown in FIG. 23, the alignment distribution (director distribution) of these liquid crystal molecules 41 is symmetrical about a straight line passing between the first common electrode 15a and the second common electrode 15b, i.e., the connection electrode 15c or the common signal line 14, as an axis. The connection electrode 15c is formed in each pixel, and the common signal line 14 is formed to be straight irrespectively of the borders of the pixels. Thereby, in a region corresponding to one pixel in the liquid crystal layer, two regions (a multi-domain) in which the respective alignment directions are different and the respective alignment patterns of the liquid crystal molecules are symmetrical about a certain reference axis can be formed.

Comparison between the results of Example 2 and the results of Example 3 shows that even when the pixel electrodes, the common electrodes, and the common signal lines are formed on different layers, the same characteristics can be achieved by providing the desired shapes to the pixel electrodes and common electrodes. Also, since two electrode pairs each consisting of a pixel electrode and a common electrode are used, two regions with the respective different alignment directions can be formed. Thereby, the light can be efficiently utilized and excellent viewing angle characteristics can be achieved. Furthermore, an excellent effect of preventing deterioration of the characteristics even when the pixel size is small can be achieved.

As shown in FIG. 24, light is uniformly transmitted in the entire region of the openings in the black matrix 51, which means that a high transmittance is maintained. Also, as shown in FIG. 25, even without consideration of the black matrix, a transmissive region that is sufficiently large and occupies a certain range is formed. Here, a slight decrease (specifically, −1%) in the transmittance actually occurred due to the uneven surface of the TFT substrate compared to that in Example 2, but this decrease has almost no influence. As shown in FIG. 26, the results were almost the same as in Example 2. That is, the luminance values are not much different at any angle, and the ends of the curves are converged to the same portion, which means that the appearance does not change at any viewing angle, and that excellent viewing angle characteristics can be achieved.

Hence, Embodiment 3 shows that an excellent transmittance and excellent viewing angle characteristics can be achieved similarly to Embodiment 2.

### Embodiment 4

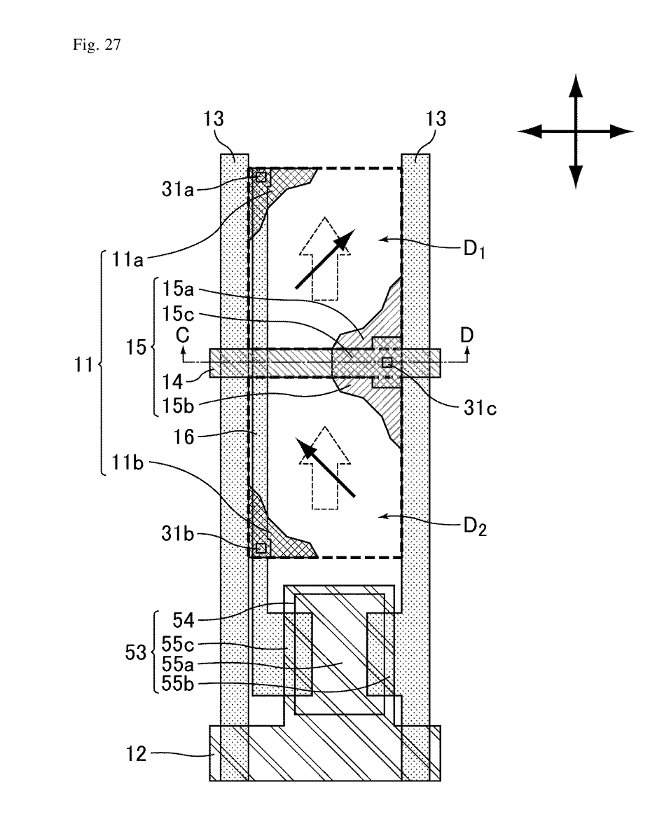

Embodiment 4 is the same as Embodiment 1, except that the shapes of the common electrodes are different, and the pixel electrodes, the common electrodes, and the common signal lines are arranged on different layers. In other words, Embodiment 4 is the same as Embodiment 3, except that the initial alignment directions of the liquid crystal molecules are different, the anisotropies of dielectric constant of the liquid crystal materials are different, and the shapes of the pixel electrodes and the common electrodes are different. FIG. 27 is a schematic plan view of a TFT substrate in a liquid crystal display device of Embodiment 4. A cross-sectional view taken along the C-D line in FIG. 27 is the same as FIG. 21.

Specific simulation with the liquid crystal display device of Embodiment 4 showed the following results (Example 4). The conditions of the simulation in Example 4 are the same as those of the simulation in Example 1, except that the shapes of the common electrodes are different, and the pixel electrodes, the common electrodes, and the common signal lines are arranged on different layers. That is, the anisotropy of dielectric constant of the liquid crystal material was negative (Δ∈=−7). The shapes of the electrodes were the same as those used in Example 1.

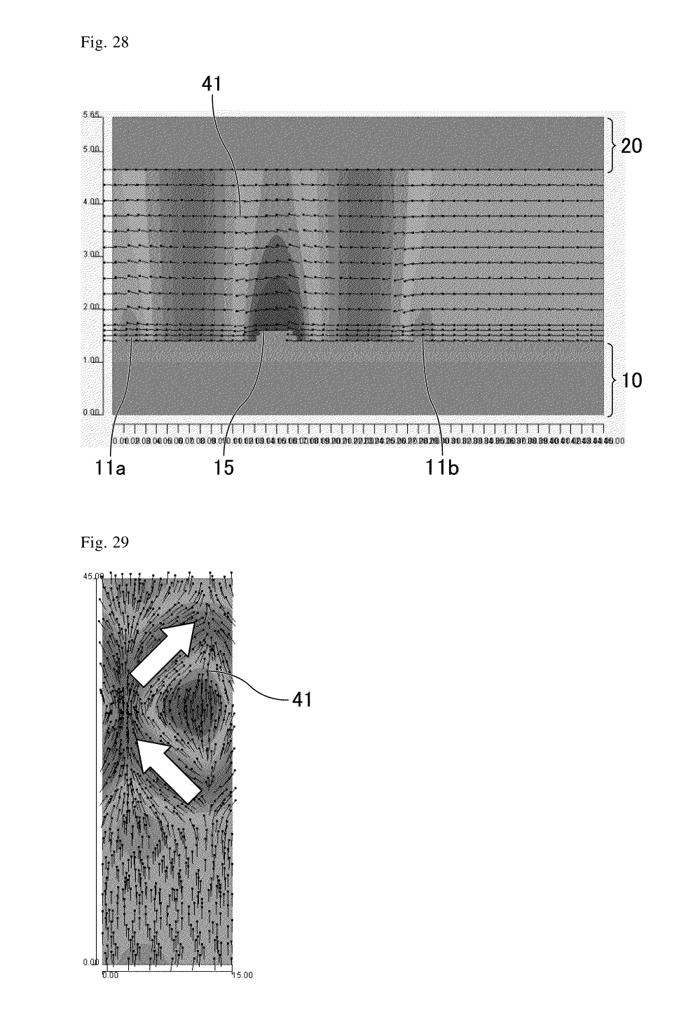

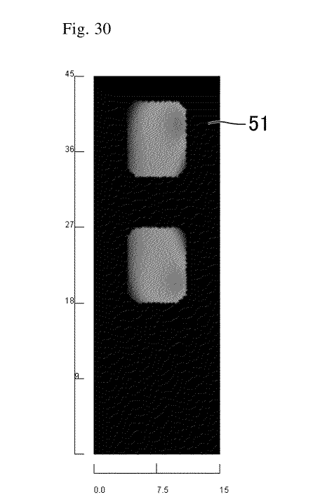

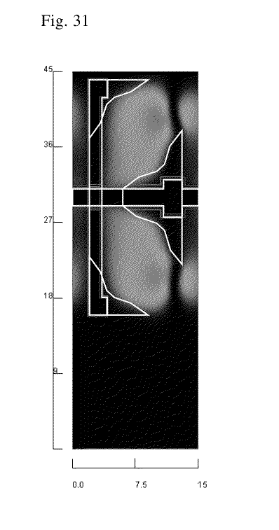

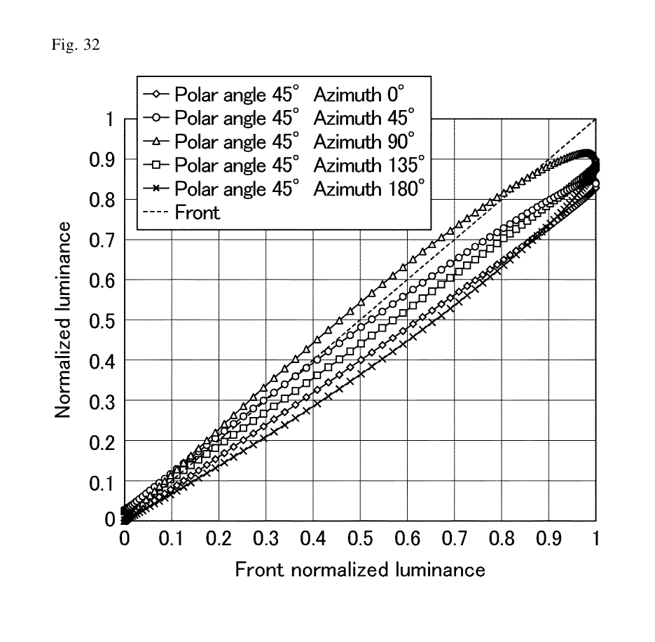

FIG. 28 and FIG. 29 are each a simulation image showing the liquid crystal molecule behavior in Example 4 in a state where white voltage is applied (10.5 V; increased by 0.8 V compared to Example 1). FIG. 28 is a cross-sectional view, and FIG. 29 is a plan view. FIG. 30 is a plan image showing the light transmittance in Example 4 in grayscale. FIG. 31 is a view obtained by removing the black matrix from and adding the positions of the electrodes to FIG. 30. FIG. 32 is a graph showing the viewing angle characteristics in Example 4, which shows the luminance values at various azimuths with the polar angle fixed at 45° from the display screen taken as the reference surface.

As shown in FIG. 28 and FIG. 29, when a voltage equal to or higher than the threshold voltage is applied, the initial alignment of the liquid crystal molecules 41 is maintained in the vicinity of the TFT substrate 10, but in the other parts, the alignment of the liquid crystal molecules 41 changes. In particular, the liquid crystal molecules 41 positioned between the pixel electrodes 11a and 11b and the common electrodes 15a and 15b facing the pixel electrodes are aligned in the direction oblique to the long sides of the pixels, though the angles thereof are different depending on the distances from the electrodes. In FIG. 28 and FIG. 29, the regions are shown in gradation that reflects the strengths of the electric fields.

As shown in FIG. 29, similarly to Example 3, the alignment distribution (director distribution) of these liquid crystal molecules 41 is symmetrical about a straight line passing between the first common electrode 15a and the second common electrode 15b, i.e., the connection electrode 15c or the common signal line 14, as an axis. The connection electrode 15c is formed in each pixel, and the common signal line 14 is formed to be straight irrespectively of the borders of the pixels. Thereby, in a region corresponding to one pixel in the liquid crystal layer, two regions (a multi-domain) in which the respective alignment directions are different and the respective alignment patterns of the liquid crystal molecules are symmetrical about a certain reference axis can be formed.

Comparison between the results of Example 1 and the results of Example 4 shows that even when the pixel electrodes, the common electrodes, and the common signal lines are formed on different layers, the same characteristics can be achieved by providing the desired shapes to the pixel electrodes and common electrodes. Also, since two electrode pairs each consisting of a pixel electrode and a common electrode are used, two regions with the respective different alignment directions can be formed. Thereby, the light can be efficiently utilized and excellent viewing angle characteristics can be achieved. Furthermore, an excellent effect of preventing deterioration of the characteristics even when the pixel size is small can be achieved.

As shown in FIG. 30, light is uniformly transmitted in the entire region of the openings in the black matrix 51, which means that a high transmittance is maintained. Also, as shown in FIG. 31, even without consideration of the black matrix, a transmissive region that is sufficiently large and occupies a certain range is formed. Here, similarly to Example 3, a slight decrease (specifically, −2%) in the transmittance actually occurred due to the uneven surface of the TFT substrate compared to that in Example 1, but this decrease has almost no influence. As shown in FIG. 32, the results were almost the same as in Example 1. That is, the luminance values are not much different at any angle, and the ends of the curves are converged to the same portion, which means that the appearance does not change at any viewing angle, and that excellent viewing angle characteristics can be achieved.

Hence, Embodiment 4 shows that an excellent transmittance and an excellent viewing angle can be achieved similarly to Embodiment 1.

### Embodiment 5

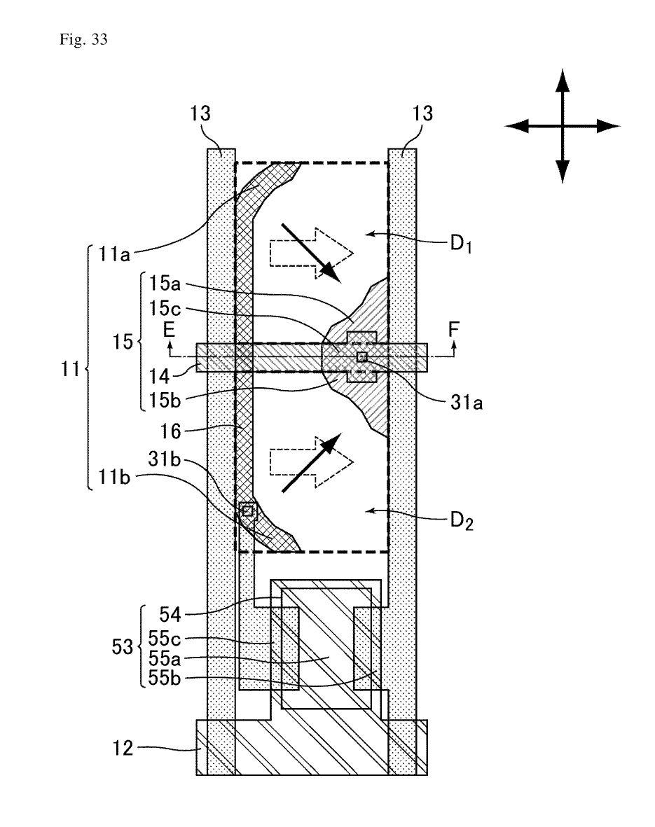

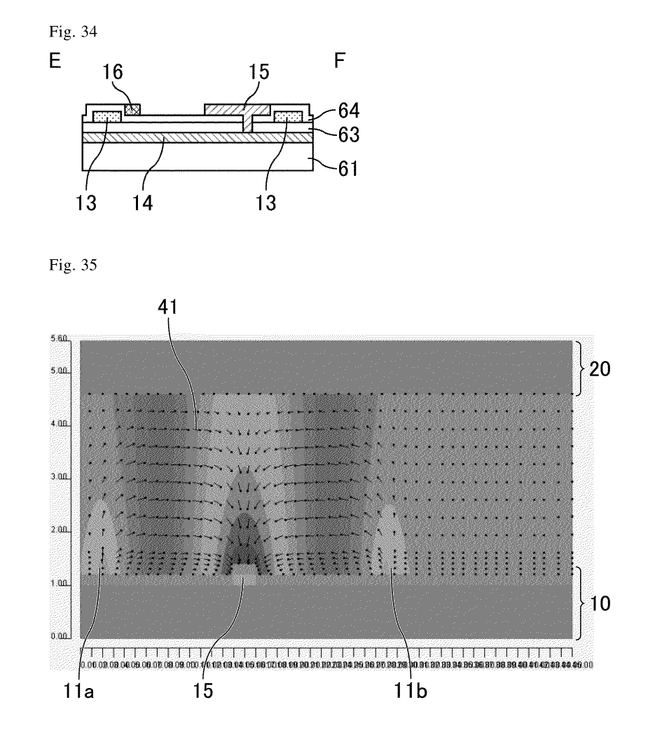

Embodiment 5 is the same as Embodiment 3, except that the pixel electrodes and the pixel electrode lines are integrally formed and arranged on the same layer, the pixel electrode lines and the data signal lines are arranged on different layers, and the pixel electrodes and the common electrodes are arranged on the same layer. FIG. 33 is a schematic plan view of a TFT substrate in a liquid crystal display device of Embodiment 5. FIG. 34 is a cross-sectional view taken along the E-F line in FIG. 33.

As illustrated in FIG. 34, the common signal line 14 is formed on the supporting substrate 61. On the common signal line 14 and the supporting substrate 61, the first insulating film 63 is formed. On the first insulating film 63, the data signal lines 13 are arranged. On the data signal lines 13, the second insulating film 64 is formed. On the second insulating film 64, the pixel electrode line 16 and the common electrode 15 are arranged.

Since the common electrode 15 and the common signal line 14 are arranged on different layers, the first common electrode 15a and the second common electrode 15b are connected to each other via the connection electrode (second connection line) 15c arranged between the first common electrode 15a and the second common electrode 15b, not via the common signal line 14. That is, the first common electrode 15a, the second common electrode 15b, and the connection electrode 15c are integrally formed and constitute a common electrode portion. The common signal line 14 and the connection electrode 15c are connected to each other via the contact portion 31a penetrating the first insulating film 63 and the second insulating film 64. Thereby, common signals can be transmitted from the common signal line 14 to the first common electrode 15c and the second common electrode 15b via the connection electrode 15c.

In Embodiment 5, due to the arrangement of the electrodes and the conductive lines on different layers, the surface of the TFT substrate 10 is likely to be uneven compared to that in Embodiments 1 and 2.

Specific simulation with the liquid crystal display device of Embodiment 5 showed the following results (Example 5). The conditions of the simulation in Example 5 are the same as those of the simulation in Example 3, except that the pixel electrodes and the pixel electrode lines are integrally formed and arranged on the same layer, the pixel electrode lines and the data signal lines are arranged on different layers, and the pixel electrodes and the common electrodes are formed on the same layer. That is, the anisotropy of dielectric constant of the liquid crystal material was positive (Δ∈=+10). As to the shapes of the electrodes, the length of each end of each electrode and the length of the inner periphery of each corner portion were shorter than those in Example 1.

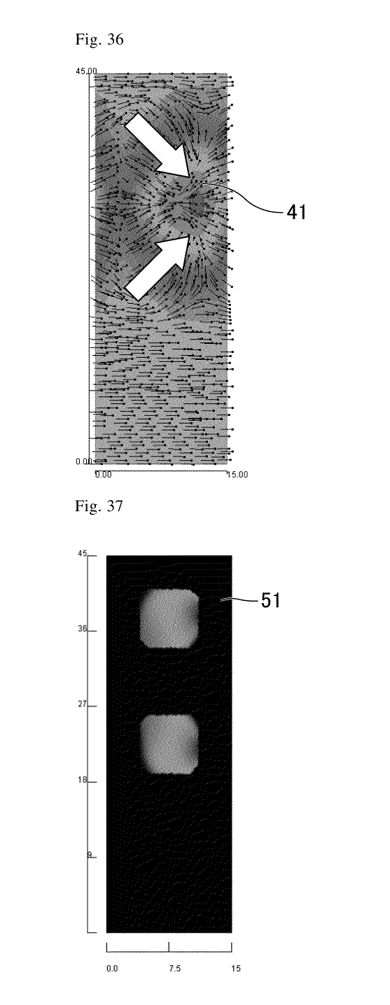

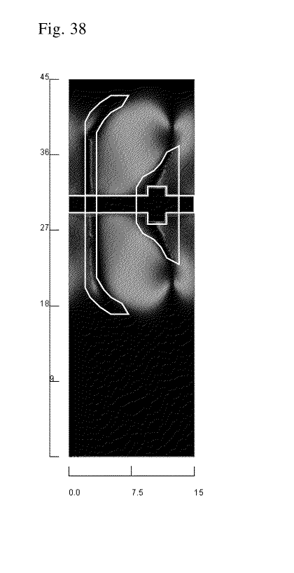

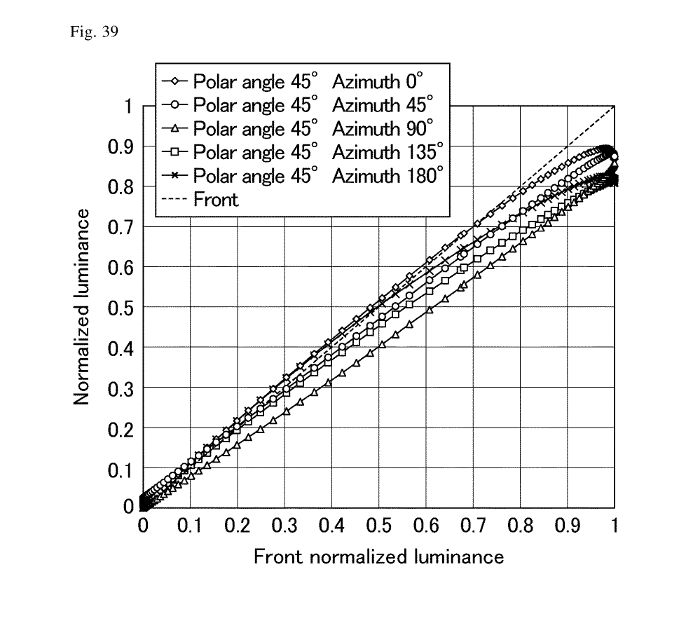

FIG. 35 and FIG. 36 are each a simulation image showing the liquid crystal molecule behavior in Example 5 in a state where white voltage is applied (8.9 V; increased by 0.9 V compared to Example 2). FIG. 35 is a cross-sectional image, and FIG. 36 is a plan image. FIG. 37 is a plan image showing the light transmittance in Example 5 in grayscale. FIG. 38 is a view obtained by removing the black matrix from and adding the positions of the electrodes to FIG. 37. FIG. 39 is a graph showing the viewing angle characteristics in Example 5, which shows the luminance values at various azimuths with the polar angle fixed at 45° from the display screen taken as the reference surface.

As shown in FIG. 35 and FIG. 36, when a voltage equal to or higher than the threshold voltage is applied, the initial alignment of the liquid crystal molecules 41 is maintained in the vicinity of the TFT substrate 10, but in the other parts, the alignment of the liquid crystal molecules 41 changes. In particular, the liquid crystal molecules 41 positioned between the pixel electrodes 11a and 11b and the common electrodes 15a and 15b facing the pixel electrodes are aligned in the direction oblique to the long sides of the pixels, though the angles thereof are different depending on the distances from the electrodes. In FIG. 35 and FIG. 36, the regions are shown in gradation that reflects the strengths of the electric fields.

As shown in FIG. 37, similarly to Example 3, the alignment distribution (director distribution) of these liquid crystal molecules 41 is symmetrical about a straight line passing between the first common electrode 15a and the second common electrode 15b, i.e., the connection electrode 15c or the common signal line 14, as an axis. The connection electrode 15c is formed in each pixel, and the common signal line 14 is formed to be straight irrespectively of the borders of the pixels. Thereby, in a region corresponding to one pixel in the liquid crystal layer, two regions (multi-domain) in which the respective alignment directions are different and the respective alignment patterns of the liquid crystal molecules are symmetrical about a certain reference axis can be formed.

Comparison between the results of Example 3 and the results of Example 5 shows that even when the pixel electrodes and the pixel electrode lines are integrally formed, the same characteristics can be achieved by providing the desired shapes to the pixel electrodes and common electrodes. Also, since two electrode pairs each consisting of a pixel electrode and a common electrode are used, two regions with the respective different alignment directions can be formed. Thereby, the light can be efficiently utilized and excellent viewing angle characteristics can be achieved. Furthermore, an excellent effect of preventing deterioration of the characteristics even when the pixel size is small can be achieved.

As shown in FIG. 37 and FIG. 38, dark regions are partially generated in the regions as openings in the black matrix 51, and the transmittance is therefore low. The transmittance actually decreased from that in Example 2 by 24%. As shown in FIG. 39, the results were almost the same as in Example 2. That is, the luminance values are not much different at any angle, and the ends of the curves are converged to the same portion, which means that the appearance does not change at any viewing angle, and that excellent viewing angle characteristics can be achieved.

Hence, Embodiment 5 shows that excellent viewing angle characteristics can be achieved similarly to Embodiment 2, even though Embodiment 5 is inferior to Embodiment 2 in terms of the transmittance.

### Embodiment 6

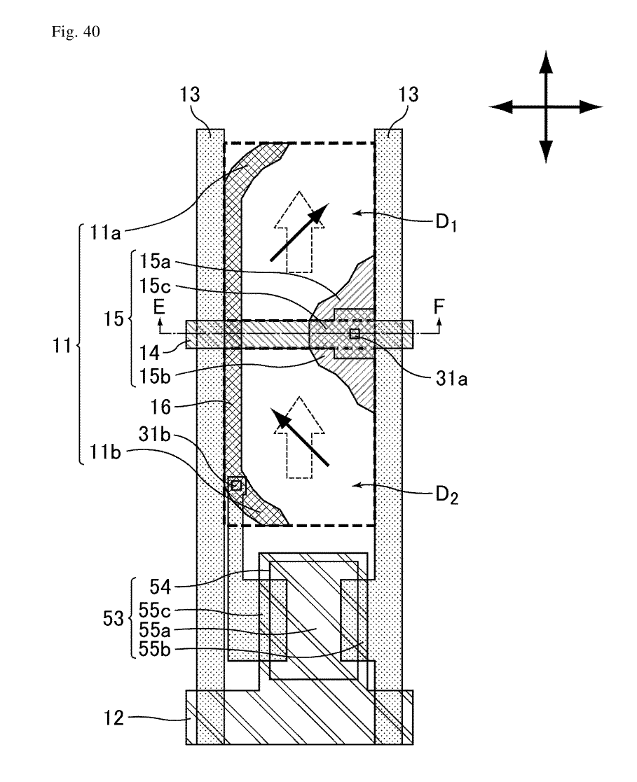

Embodiment 6 is the same as Embodiment 4, except that the pixel electrodes and the pixel electrode lines are integrally formed and arranged on the same layer, the pixel electrode lines and the data signal lines are arranged on different layers, and the pixel electrodes and the common electrodes are formed on the same layer. In other words, Embodiment 6 is the same as Embodiment 5, except that the initial alignment directions of the liquid crystal molecules are different, the anisotropies of dielectric constant of the liquid crystal materials are different, and the shapes of the pixel electrodes and the common electrodes are different. FIG. 40 is a schematic plan view of a TFT substrate in a liquid crystal display device of Embodiment 6. A cross-sectional view taken along the E-F line in FIG. 40 is the same as FIG. 34.

Specific simulation with the liquid crystal display device of Embodiment 6 showed the following results (Example 6). The conditions of the simulation in Example 6 are the same as those of the simulation in Example 4, except that the pixel electrodes and the pixel electrode lines are integrally formed and arranged on the same layer, the pixel electrode lines and the data signal lines are arranged on different layers, and the pixel electrodes and the common electrodes are arranged on the same layer. That is, the anisotropy of dielectric constant of the liquid crystal material was negative (Δ∈=−7). The shapes of the electrodes were the same as those used in Example 1.

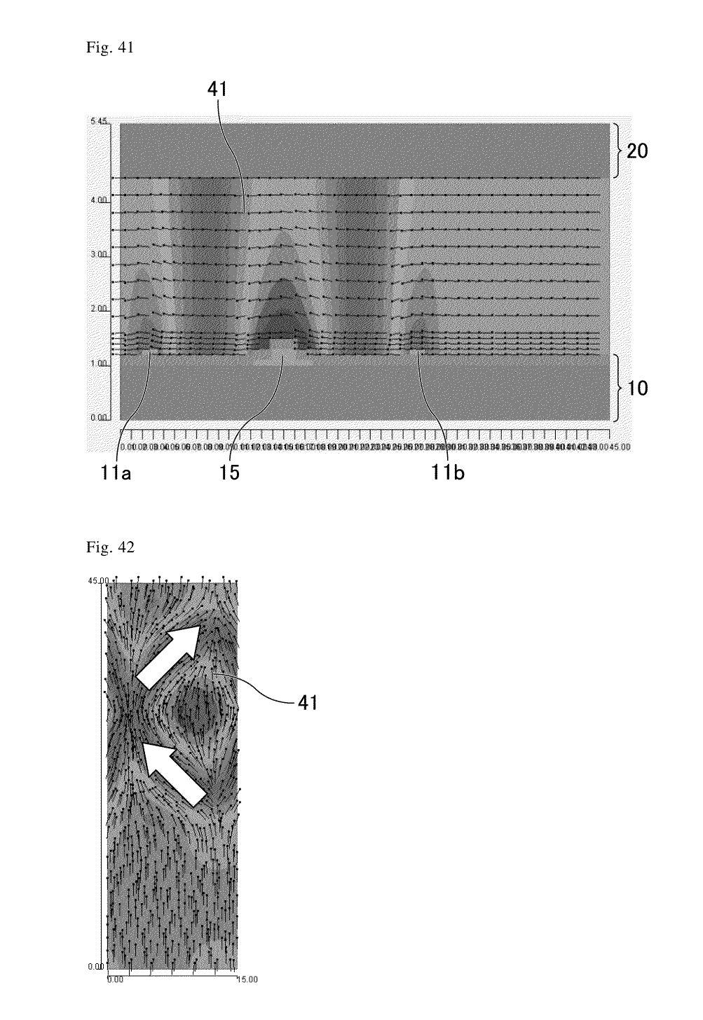

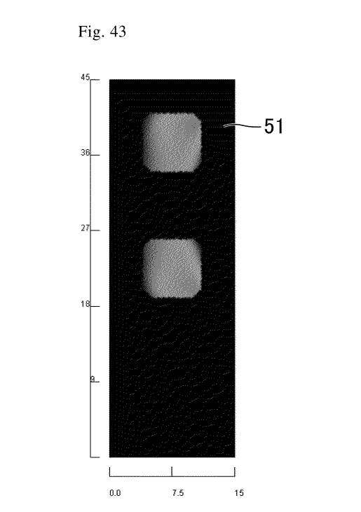

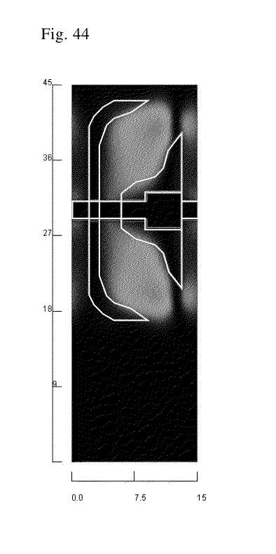

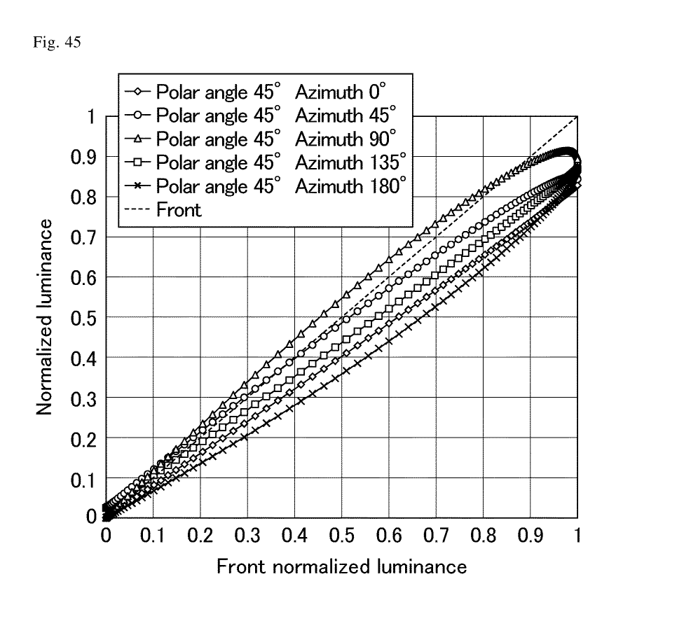

FIG. 41 and FIG. 42 are each a simulation image showing the liquid crystal molecule behavior in Example 6 in a state where white voltage is applied (10.5 V; increased by 0.8 V compared to Example 1). FIG. 41 is a cross-sectional image, and FIG. 42 is a plan image. FIG. 43 is a plan image showing the light transmittance in Example 6 in grayscale. FIG. 44 is a view obtained by removing the black matrix from and adding the positions of the electrodes to FIG. 43. FIG. 45 is a graph showing the viewing angle characteristics in Example 6, which shows the luminance values at various azimuths with the polar angle fixed at 45° from the display screen taken as the reference surface.

As shown in FIG. 41 and FIG. 42, when a voltage equal to or higher than the threshold voltage is applied, the initial alignment of the liquid crystal molecules 41 is maintained in the vicinity of the TFT substrate 10, but in the other parts, the alignment of the liquid crystal molecules 41 changes. In particular, the liquid crystal molecules 41 positioned between the pixel electrodes 11a and 11b and the common electrodes 15a and 15b facing the pixel electrodes are aligned in the direction oblique to the long sides of the pixels, though the angles thereof are different depending on the distances from the electrodes. In FIG. 41 and FIG. 42, the regions are shown in gradation that reflects the strengths of the electric fields.

As shown in FIG. 42, similarly to Example 5, the alignment distribution (director distribution) of these liquid crystal molecules 41 is symmetrical about a straight line passing between the first common electrode 15a and the second common electrode 15b, i.e., the connection electrode 15c or the common signal line 14, as an axis. The connection electrode 15c is formed in each pixel, and the common signal line 14 is formed to be straight irrespectively of the borders of the pixels. Thereby, in a region corresponding to one pixel in the liquid crystal layer, two regions (multi-domain) in which the respective alignment directions are different and the respective alignment patterns of the liquid crystal molecules are symmetrical about a certain reference axis can be formed.

Comparison between the results of Example 4 and the results of Example 6 shows that even when the pixel electrodes and the pixel electrode lines are formed on the same layer, the same characteristics can be achieved by providing the desired shapes to the pixel electrodes and common electrodes. Also, since two electrode pairs each consisting of a pixel electrode and a common electrode are used, two regions with the respective different alignment directions can be formed. Thereby, the light can be efficiently utilized and excellent viewing angle characteristics can be achieved. Furthermore, an excellent effect of preventing deterioration of the characteristics even when the pixel size is small can be achieved.

As shown in FIG. 43, light is uniformly transmitted in the entire region of the openings in the black matrix 51, which means that a high transmittance is maintained. Also, as shown in FIG. 44, even without consideration of the black matrix, a transmissive region that is sufficiently large and occupies a certain range is formed. Here, a slight decrease (specifically, −2%) in the transmittance actually occurred due to the uneven surface of the TFT substrate compared to Example 1, but this decrease has almost no influence. As shown in FIG. 45, the results were almost the same as in Examples 1 and 4. The luminance values are not much different at any angle, and the ends of the curves are converged to the same portion, which means that the appearance does not change at any viewing angle, and that excellent viewing angle characteristics can be achieved.

Hence, Embodiment 6 shows that an excellent transmittance and an excellent viewing angle can be achieved similarly to Embodiment 1.

### Embodiment 7

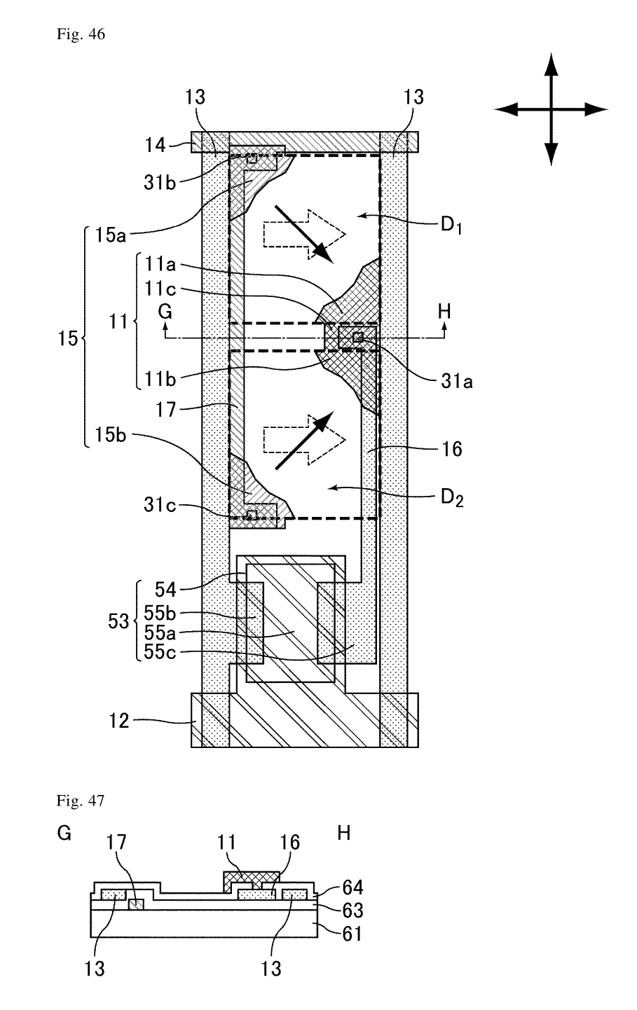

Embodiment 7 is the same as Embodiment 2, except that the positions of the pixel electrodes and the positions of the common electrodes are switched, and the positions of the conductive lines designed to supply signals to these electrodes are different. In Embodiment 7, the pixel electrodes and the common electrodes are arranged on the same layer, and the pixel electrode lines connecting the pixel electrodes to each other and the common electrode lines connecting the common electrodes to each other are arranged on different layers. FIG. 46 is a schematic plan view of a TFT substrate in the liquid crystal display device of Embodiment 7. FIG. 47 is a schematic cross-sectional view taken along the G-H line in FIG. 46.

As shown in FIG. 47, the common electrode line 17 is formed on the supporting substrate 61. In Embodiment 7, the pixel electrode line (first connection line) 16 can be a conductive line extended from the drain electrode 55c of the TFT 53. On the common electrode line 17 and the supporting substrate 61, the first insulating film 63 is formed. On the first insulating film 63, the data signal lines 13 and the pixel electrode line 16 are arranged. On the data signal lines 13, the pixel electrode line 16, and the first insulating film 63, the second insulating film 64 is formed. On the second insulating film 64, the pixel electrode 11 is arranged.

The first pixel electrode 11a and the second pixel electrode 11b are connected to each other via the connection electrode (second connection line) 11c arranged between the first pixel electrode 11a and the second pixel electrode 11b. That is, the first pixel electrode 11a, the second pixel electrode 11b, and the connection electrode 11c are integrally formed and constitute the common electrode portion. In Embodiment 7, the drain electrode 55c extended from the TFT 53 is further extended to form the pixel electrode line 16. The pixel electrode line 16 is connected to the connection electrode 11c via the contact portion 31a penetrating the second insulating film 64. Thereby, pixel signals are transferred in the order of the drain electrode 55c, the pixel electrode line 16, the connection electrode 11c, and the first pixel electrode 11a or the second pixel electrode 11b.

In Embodiment 7, the common signal line 14 extending in parallel with the scanning signal line 12 is arranged on the upper side of the pixel in the figure, differently from Embodiments 1 to 6. The common signal line 14 is integrally formed with the common electrode line 17. The common electrode line 17 is connected to the first common electrode 15a via the contact portion 31b penetrating the first insulating film 63 and the second insulating film 64, and is connected to the second common electrode 15b via the contact portion 31c penetrating the first insulating film 63 and the second insulating film 64. Thereby, common signals are transferred in the order of the common signal line 14, the common electrode line 17, and the first common electrode 15a or the second common electrode 15b.

Specific simulation with the liquid crystal display device of Embodiment 7 showed the following results (Example 7). The conditions of the simulation in Example 7 are the same as those of the simulation in Example 2, except that the positions of the pixel electrodes and the positions of the common electrodes are switched, and the positions of the connection lines for supplying signals to the electrodes are changed. That is, the anisotropy of dielectric constant of the liquid crystal material was positive (Δ∈=+10). As to the shapes of the electrodes, the length of each end of each electrode and the length of the inner periphery of each corner portion were shorter than those in Example 1.

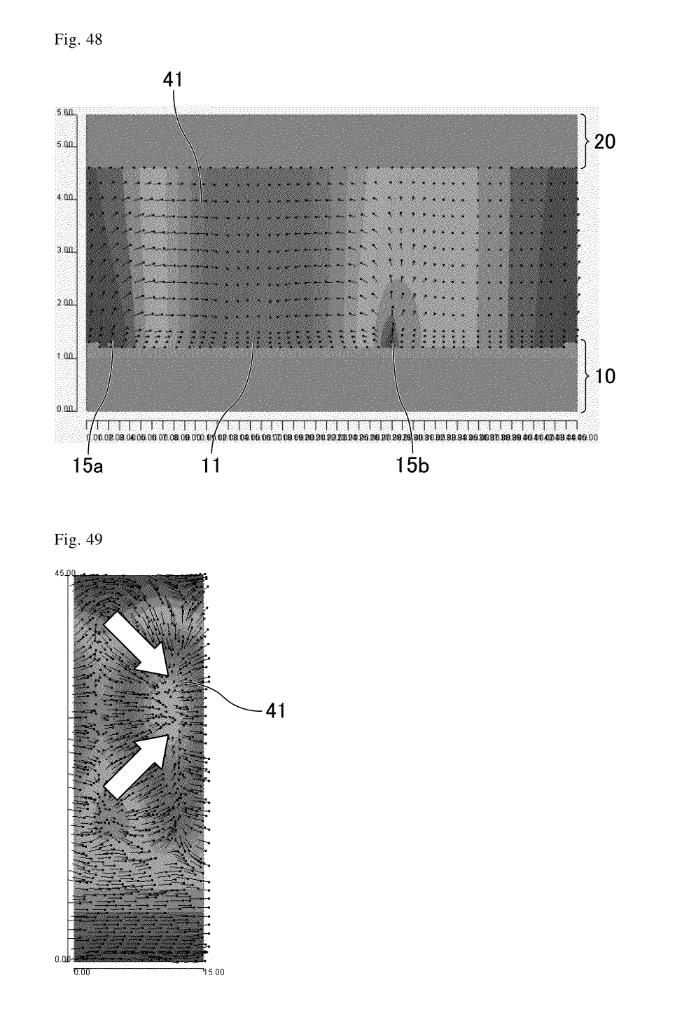

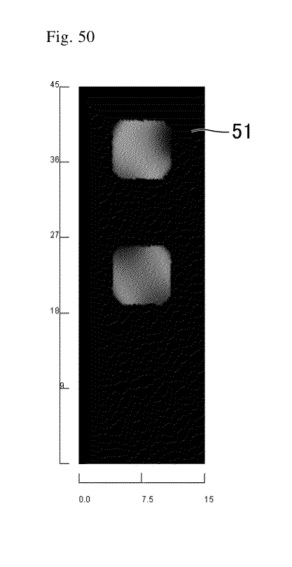

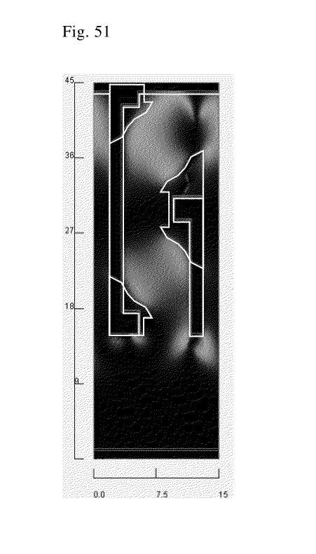

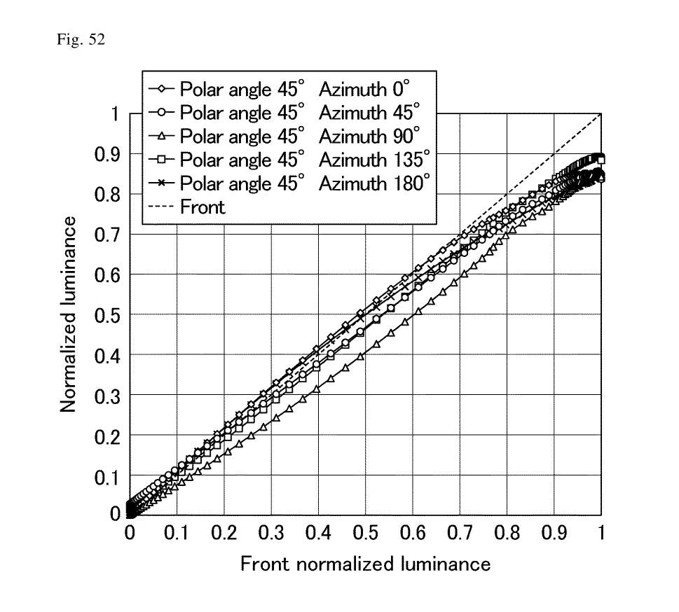

FIG. 48 and FIG. 49 are each a simulation image showing the liquid crystal molecule behavior in Example 7 in a state where white voltage is applied (10.8 V; increased by 2.8 V compared to Example 2). FIG. 48 is a cross-sectional view, and FIG. 49 is a plan view. FIG. 50 is a plan image showing the light transmittance in Example 7 in grayscale. FIG. 51 is a view obtained by removing the black matrix from and adding the positions of the electrodes to FIG. 50. FIG. 52 is a graph showing the viewing angle characteristics in Example 7, which shows the luminance values at various azimuths with the polar angle fixed at 45° from the display screen taken as the reference surface.

As shown in FIG. 48 and FIG. 49, when a voltage equal to or higher than the threshold voltage is applied, the initial alignment of the liquid crystal molecules 41 is maintained in the vicinity of the TFT substrate 10, but in the other parts, the alignment of the liquid crystal molecules 41 changes. In particular, the liquid crystal molecules 41 positioned between the pixel electrodes 11a and 11b and the common electrodes 15a and 15b facing the pixel electrodes are aligned in the direction oblique to the long sides of the pixels, though the angles thereof are different depending on the distances from the electrodes. In FIG. 48 and FIG. 49, the regions are shown in gradation that reflects the strengths of the electric fields.

As shown in FIG. 49, in Example 7, the alignment distribution (director distribution) of these liquid crystal molecules 41 is symmetrical about a straight line passing between the first common electrode 11a and the second common electrode 11b, i.e., the connection electrode 11c as an axis. The connection electrode 11c is formed in each pixel. Thereby, in a region corresponding to one pixel in the liquid crystal layer, two regions (multi-domain) in which the respective alignment directions are different and the respective alignment patterns of the liquid crystal molecules are symmetrical about a certain reference axis can be formed.

Comparison between the results of Example 2 and the results of Example 7 shows that when the positions of the pixel electrodes and the conductive lines are switched, the alignment directions of the liquid crystal molecules are different. Here, since two electrode pairs each consisting of a pixel electrode and a common electrode are used, two regions with the respective different alignment directions can be formed. Thereby, the light can be efficiently utilized and favorable viewing angle characteristics can be achieved.

As shown in FIG. 50 and FIG. 51, dark regions are partially generated in the regions as openings in the black matrix 51, and the transmittance is therefore low. The transmittance actually decreased from that in Example 2 by 33%. As shown in FIG. 52, the luminance values are not much different at any angle even though the luminance values are slightly varied compared to Example 2, and the ends of the curves are converged to the same portion, which means that sufficient viewing angle characteristics can be achieved.

As described above, although Embodiment 7 is inferior to Embodiment 2 in terms of the transmittance, Embodiment 7 still can achieve sufficient viewing angle characteristics.

### Embodiment 8

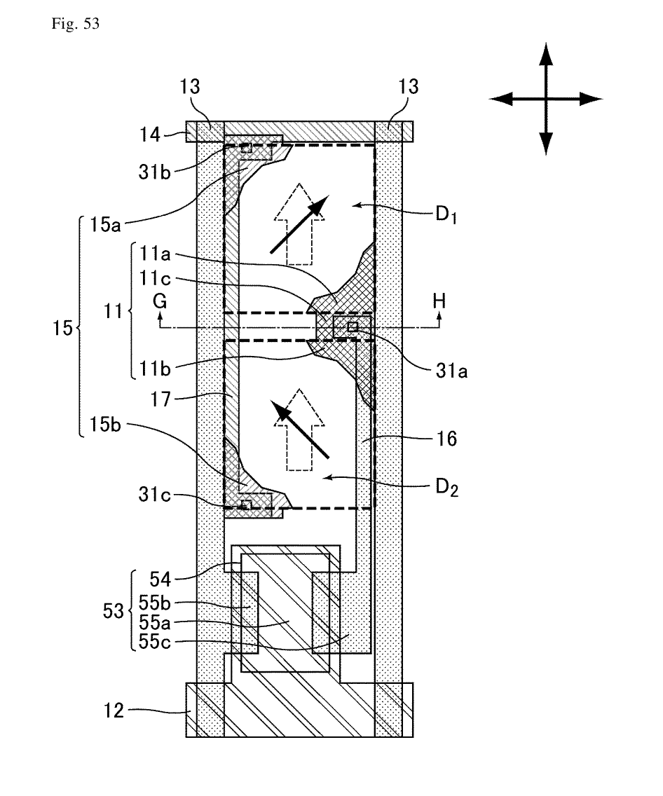

Embodiment 8 is the same as Embodiment 1, except that the positions of the pixel electrodes and the positions of the common electrodes are switched, and the positions of the conductive lines are designed to supply signals to these electrodes are switched. In other words, Embodiment 8 is the same as Embodiment 7, except that the initial alignment directions of the liquid crystal molecules are different, the anisotropies of dielectric constant of the liquid crystal materials are different, and the shapes of the pixel electrodes and the common electrodes are different. FIG. 53 is a schematic plan view of a TFT substrate in the liquid crystal display device of Embodiment 8. A cross-sectional view taken along the G-H line in FIG. 53 is the same as FIG. 47.

Specific simulation with the liquid crystal display device of Embodiment 8 showed the following results (Example 8). The conditions of the simulation in Example 8 are the same as those of the simulation in Example 1, except that the positions of the pixel electrodes and the positions of the common electrodes are switched, and the positions of the conductive lines for supplying signals to the electrodes are changed. That is, the anisotropy of dielectric constant of the liquid crystal material was negative (Δ∈=−7). The shapes of the electrodes were the same as those used in Example 1.

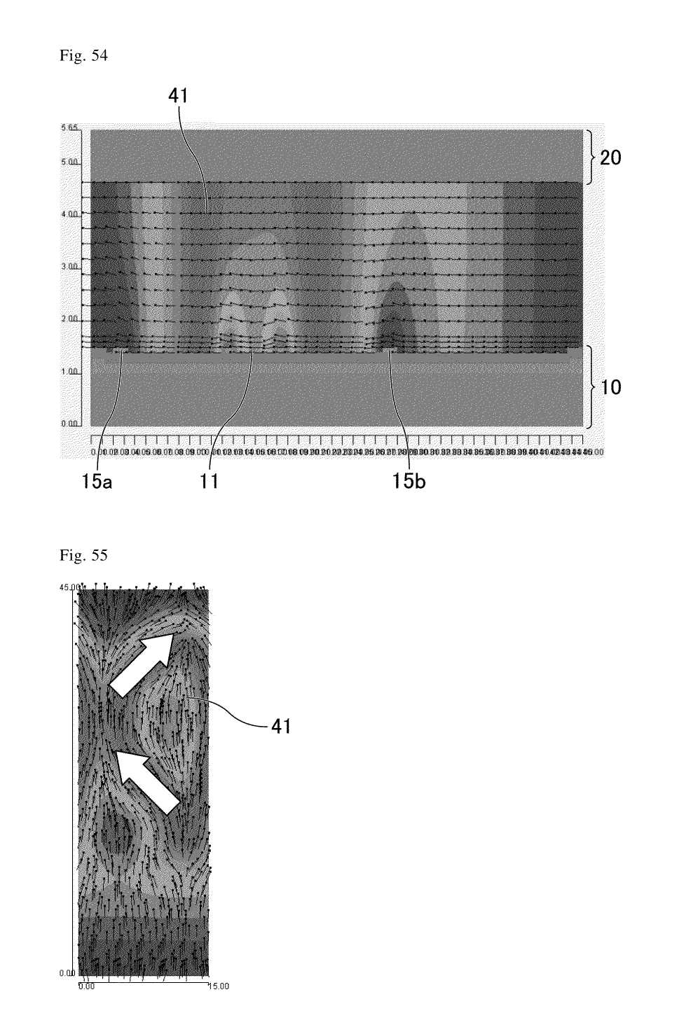

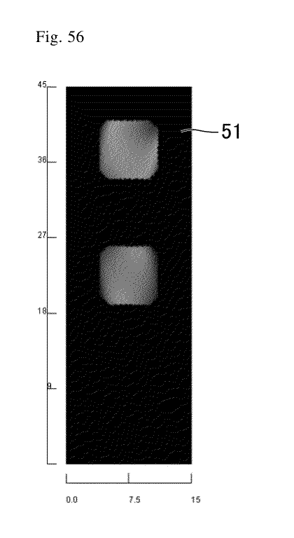

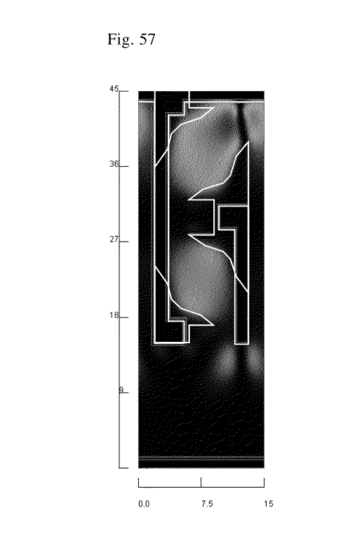

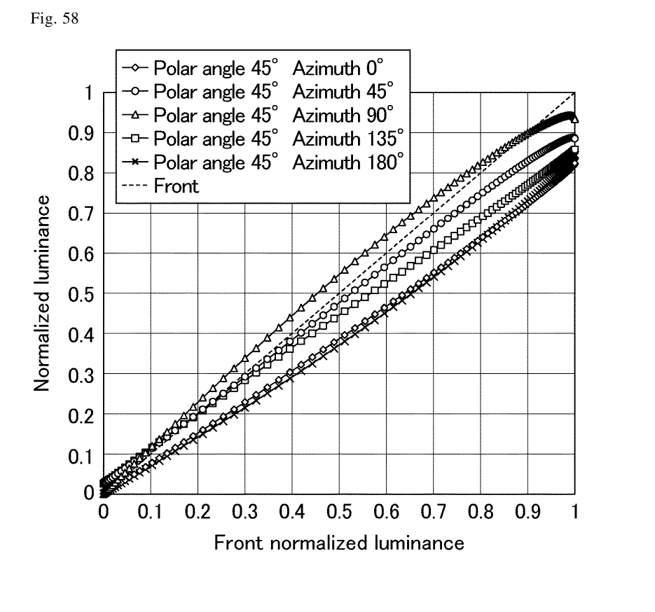

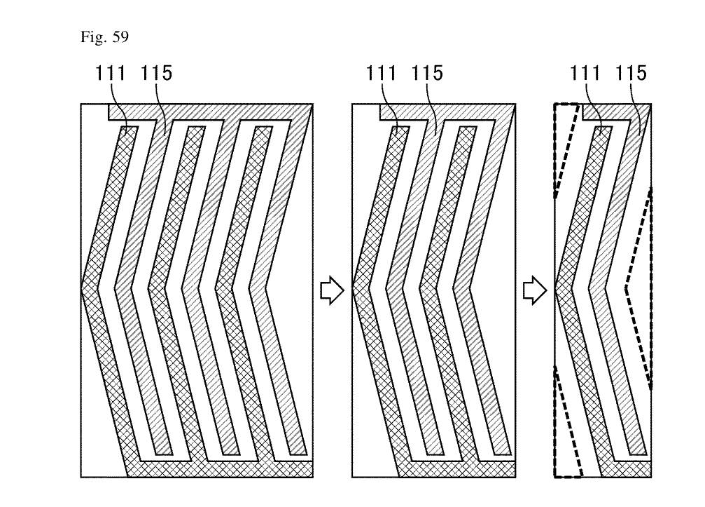

FIG. 54 and FIG. 55 are each a simulation image showing the liquid crystal molecule behavior in Example 8 in a state where white voltage is applied (14.0 V; increased by 4.3 V compared to Example 1). FIG. 54 is a cross-sectional view, and FIG. 55 is a plan view. FIG. 56 is a plan image showing the light transmittance in Example 8 in grayscale. FIG. 57 is a view obtained by removing the black matrix from and adding the positions of the electrodes to FIG. 56. FIG. 58 is a graph showing the viewing angle characteristics in Example 8, which shows the luminance values at various azimuths with the polar angle fixed at 45° from the display screen taken as the reference surface.

As shown in FIG. 54 and FIG. 55, when a voltage equal to or higher than the threshold voltage is applied, the initial alignment of the liquid crystal molecules 41 is maintained in the vicinity of the TFT substrate 10, but in the other parts, the alignment of the liquid crystal molecules 41 changes. In particular, the liquid crystal molecules 41 positioned between the pixel electrodes 11a and 11b and the common electrodes 15a and 15b facing the pixel electrodes are aligned in the direction oblique to the long sides of the pixels, though the angles thereof are different depending on the distances from the electrodes. In FIG. 54 and FIG. 55, the regions are shown in gradation that reflects the strengths of the electric fields.

As shown in FIG. 55, in Example 8, the alignment distribution (director distribution) of these liquid crystal molecules 41 is symmetrical about a straight line passing between the first common electrode 11a and the second common electrode 11b, i.e., the connection electrode 11c, as an axis. The connection electrode 11c is formed in each pixel. Thereby, in a region corresponding to one pixel in the liquid crystal layer, two regions (multi-domain) in which the respective alignment directions are different and the respective alignment patterns of the liquid crystal molecules are symmetrical about a certain reference axis can be formed.

Comparison between the results of Example 1 and the results of Example 8 shows that even when the positions of the pixel electrodes and the conductive lines are switched, the alignment directions of the liquid crystal molecules are different. Here, since two electrode pairs each consisting of a pixel electrode and a common electrode are used, two regions with the respective different alignment directions can be formed. Thereby, the light can be efficiently utilized, and excellent viewing angle characteristics can be achieved.

As shown in FIG. 56 and FIG. 57, dark regions are partially generated in the regions as openings in the black matrix 51, and the transmittance is therefore low. The transmittance actually decreased from that in Example 1 by 31%. As shown in FIG. 58, the ends of the curves are slightly varied compared to Example 1, but the luminance values are not much different at any angle, and the appearance does not change much at any viewing angle, which means that sufficient viewing angle characteristics can be achieved.

As described above, although Embodiment 8 is inferior to Embodiment 1 in terms of the transmittance, Embodiment 8 still can achieve sufficient viewing angle characteristics.

### REFERENCE SIGNS LIST

10: TFT substrate (first substrate)
11: Pixel electrode (first hook-like electrode)
11a: First pixel electrode
11b: Second pixel electrode
11c: Connection electrode
12: Scanning signal line
13: Data signal line
14: Common signal line
15: Common electrode (second hook-like electrode)
15a: First common electrode
15b: Second common electrode
15c: Connection electrode
16: Pixel electrode line (first connection line)
17: Common electrode line (second connection line)
20: Counter substrate (second substrate)
31a, 31b, 31c: Contact portion
40: Liquid crystal layer
41: Liquid crystal molecule
51: Black matrix
53: TFT
54: Semiconductor layer
55a: Gate electrode
55b: Source electrode
55c: Drain electrode
61, 62: Supporting substrate
63: First insulating layer
64: Second insulating layer
111: Pixel electrode (comb-teeth shaped)
115: Common electrode (comb-teeth shaped)
D1: First divisional region
D2: Second divisional region
D3: Empty region

1. A liquid crystal display device comprising:
a first substrate;
a second substrate; and
a liquid crystal layer sandwiched between the first substrate and the second substrate,
the first substrate provided with electrode pairs each including a first hook-like electrode and a second hook-like electrode that are independent of each other,
the first hook-like electrodes, included in respective two adjacent electrode pairs, being connected to each other by a first connection line,
the second hook-like electrodes, included in the respective two adjacent electrode pairs, being connected to each other by a second connection line,
the first hook-like electrode included in one of the two adjacent electrode pairs and the first hook-like electrode included in the other of the two adjacent electrode pairs arranged symmetrically about the second connection line arranged between the electrode pairs as a reference axis, and the second hook-like electrode included in one of the two adjacent electrode pairs and the second hook-like electrode included in the other of the two adjacent electrode pairs arranged symmetrically about the second connection line,
the inner periphery of the first hook-like electrode and the inner periphery of the second hook-like electrode in each pair facing each other in a plan view of the first substrate.

2. The liquid crystal display device according to claim 1,
wherein the second hook-like electrodes included in the respective two adjacent electrode pairs and the second connection line are arranged on the same layer,
the second connection line is arranged to fill a space between the second hook-like electrodes included in the respective two adjacent electrode pairs in a plan view of the first substrate, and
the second hook-like electrodes included in the respective two adjacent electrode pairs and the second connection line are integrally formed.

3. The liquid crystal display device according to claim 1,
wherein in a plan view of the first substrate, at least one end portion of at least one of the first hook-like electrodes has a sharp tip.

4. The liquid crystal display device according to claim 1,
wherein in a plan view of the first substrate, at least one end portion of at least one of the second hook-like electrodes has a sharp tip.

5. The liquid crystal display device according to claim 1,
wherein in a plan view of the first substrate, the inner periphery of at least one of the first hook-like electrodes is defined by at least three lines with different slopes.

6. The liquid crystal display device according to claim 1,
wherein in a plan view of the first substrate, the inner periphery of at least one of the second hook-like electrodes is defined by at least three lines with different slopes.

7. The liquid crystal display device according to claim 1,
wherein in a plan view of the first substrate,
the inner periphery of at least one of the first hook-like electrodes is defined by at least three lines with different slopes,
the inner periphery of at least one of the second hook-like electrodes is defined by at least three lines with different slopes, and
any one line of the at least three lines with different slopes included in the inner periphery of the first hook-like electrode is in parallel with any one line of the at least three lines with different slopes included in the inner periphery of the second hook-like electrode.

8. The liquid crystal display device according to claim 1,
wherein in a plan view of the first substrate, the inner periphery of at least one of the first hook-like electrodes is bent.

9. The liquid crystal display device according to claim 1,
wherein in a plan view of the first substrate, the inner periphery of at least one of the second electrodes is bent.

10. The liquid crystal display device according to claim 1,
wherein in a plan view of the first substrate, the first hook-like electrode and the second hook-like electrode in at least one pair are symmetrical about a straight line passing between the first hook-like electrode and the second hook-like electrode as an axis.

11. The liquid crystal display device according to claim 1,
wherein in a plan view of the first substrate, the first hook-like electrode and the second hook-like electrode in at least one pair are symmetrical about a point positioned between the first hook-like electrode and the second hook-like electrode.

12. The liquid crystal display device according to claim 1,
wherein the first hook-like electrodes and the second hook-like electrodes are arranged on the same layer.

13. The liquid crystal display device according to claim 1,
wherein the first substrate is further provided with a first polarizer,
the second substrate is further provided with a second polarizer,
the polarization axis of the first polarizer and the polarization axis of the second polarizer are orthogonal to each other,
in a plan view of the first substrate, the inner periphery of at least one of the first hook-like electrodes is at an angle with the polarization axis of the first polarizer and the polarization axis of the second polarizer, and
in a plan view of the first substrate, the inner periphery of at least one of the second hook-like electrodes is at an angle with the polarization axis of the first polarizer and the polarization axis of the second polarizer.
